(19) United States
(12) Patent Application Publication
(10) Pub. No.: US 2024/0365290 A1
(43) Pub. Date: Oct. 31, 2024

(54) SUBBAND FULL-DUPLEX COMMUNICATIONS BASED ON MULTIPLE UPLINK SHARED CHANNEL OCCASIONS IN A CONFIGURED GRANT PERIOD

(71) Applicant: QUALCOMM Incorporated, San Diego, CA (US)

(72) Inventors: Diana MAAMARI, San Diego, CA (US); Mickael MONDET, Louannec (FR); Muhammad Sayed Khairy ABDELGHAFFAR, San Jose, CA (US); Jing SUN, San Diego, CA (US); Huilin XU, Temecula, CA (US); Ahmed ELSHAFIE, San Diego, CA (US); Ahmed Attia ABOTABL, San Diego, CA (US)

(21) Appl. No.: 18/309,562

(22) Filed: Apr. 28, 2023

(51) Int. Cl. H04W 72/04; H04L 5/14

(52) U.S. Cl. CPC H04W 72/04; H04L 5/14

(57) ABSTRACT

Methods, systems, and devices for wireless communication are described. A user equipment (UE) may receive an indication of a first frequency resource allocation associated with a first slot type and, in some cases, a second frequency resource allocation associated with a second slot type for a configured grant (CG). The CG may be associated with half-duplex (HD) slots and subband full-duplex (SBFD) slots. The UE may transmit an uplink message to a network entity via a first set of one or more slots associated with the CG using the first frequency allocation based on the first set of one or more slots being of the first slot type. The UE may cancel a use of the first frequency allocation for transmitting the PUSCH via a second set of one or more slots if the second set of slots is of the second slot type.

### TECHNICAL FIELD

The following relates to wireless communication, including subband full-duplex (SBFD) communications based on multiple uplink shared channel occasions in a configured grant period.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE). Components within a wireless communication system may be coupled (for example, operatively, communicatively, functionally, electronically, and/or electrically) to each other.

### SUMMARY

The described techniques relate to improved methods, systems, devices, and apparatuses that support subband full-duplex (SBFD) communications based on multiple uplink shared channel occasions in a configured grant period. For example, the described techniques provide for multiple uplink channel occasions in a single configured grant (CG) for half-duplex (HD) and SBFD communication. A user equipment (UE) may receive signaling indicating a CG for uplink transmissions and the CG may include both HD and SBFD slots. The UE may receive an indication of a first frequency resource allocation applicable to a first slot type (e.g., one of an HD slot type or an SBFD slot type) for the CG. In addition, the UE may receive an indication of a second frequency resource allocation associated with a second slot type (e.g., the other of the HD slot type or the SBFD slot type), where the first and second slot types are different. The second frequency resource allocation may be explicitly signaled or may be implicitly signaled with reference to the first frequency resource allocation. The UE may transmit a first uplink message via a first set of slots using the first frequency resource allocation given that the first set of slots are of the first slot type. Accordingly, the UE may refrain from using or cancel use of the first frequency allocation for transmitting an uplink message via a second set of slots of the second slot type. Additionally, or alternatively, the UE may transit a second uplink message via the second set of slots and using the second frequency resource allocation based on the second set of slots being of the second slot type.

A method for wireless communication at a UE is described. The method may include receiving an indication of a first frequency allocation associated with a first slot type for a CG, transmitting a first uplink message via a first set of one or more slots associated with the CG using the first frequency allocation based on the first set of one or more slots being of the first slot type, and cancelling a use of the first frequency allocation for transmitting via a second set of one or more slots associated with the CG based on the second set of one or more slots being of a second slot type that is different from the first slot type.

An apparatus for wireless communication at a UE is described. The apparatus may include at least one processor, and memory coupled (e.g., operatively, communicatively, functionally, electronically, or electrically) with the at least one processor, the memory storing instructions executable by the at least one processor (e.g., directly, indirectly, after pre-processing, without pre-processing) to cause the UE to receive an indication of a first frequency allocation associated with a first slot type for a CG, transmit a first uplink message via a first set of one or more slots associated with the CG using the first frequency allocation based on the first set of one or more slots being of the first slot type, and cancel a use of the first frequency allocation for transmitting via a second set of one or more slots associated with the CG based on the second set of one or more slots being of a second slot type that is different from the first slot type.

Another apparatus for wireless communication at a UE is described. The apparatus may include means for receiving an indication of a first frequency allocation associated with a first slot type for a CG, means for transmitting a first uplink message via a first set of one or more slots associated with the CG using the first frequency allocation based on the first set of one or more slots being of the first slot type, and means for cancelling a use of the first frequency allocation for transmitting via a second set of one or more slots associated with the CG based on the second set of one or more slots being of a second slot type that is different from the first slot type.

A non-transitory computer-readable medium storing code for wireless communication at a UE is described. The code may include instructions executable by at least one processor (e.g., directly, indirectly, after pre-processing, without pre-processing) to receive an indication of a first frequency allocation associated with a first slot type for a CG, transmit a first uplink message via a first set of one or more slots associated with the CG using the first frequency allocation based on the first set of one or more slots being of the first slot type, and cancel a use of the first frequency allocation for transmitting via a second set of one or more slots associated with the CG based on the second set of one or more slots being of a second slot type that is different from the first slot type.

Some examples of the method, apparatuses, and non-transitory computer-readable medium described herein may further include operations, features, means, or instructions for receiving an indication of a second frequency allocation associated with the second slot type for the CG and transmitting a second uplink message via the second set of one or more slots associated with the CG using the second frequency allocation based on the second set of one or more slots being of the second slot type.

In some examples of the method, apparatuses, and non-transitory computer-readable medium described herein, the first slot type may be a SBFD slot type and the second slot type may be a HD slot type, or where the first slot type may be the HD slot type and the second slot type may be the SBFD slot type.

Some examples of the method, apparatuses, and non-transitory computer-readable medium described herein may further include operations, features, means, or instructions for mapping the first frequency allocation to an uplink subband of the second set of one or more slots based on applying an offset to the uplink subband with respect to the first set of one or more slots.

In some examples of the method, apparatuses, and non-transitory computer-readable medium described herein, the uplink subband may be offset from the first set of one or more slots by a quantity of resource blocks, a quantity of subbands, or both.

Some examples of the method, apparatuses, and non-transitory computer-readable medium described herein may further include operations, features, means, or instructions for selecting the first frequency allocation for transmission of the first uplink message based on the first set of one or more slots being of the first slot type.

Some examples of the method, apparatuses, and non-transitory computer-readable medium described herein may further include operations, features, means, or instructions for selecting a second frequency allocation for transmission of a second uplink message based on the second set of one or more slots being of the second slot type.

In some examples of the method, apparatuses, and non-transitory computer-readable medium described herein, the first frequency allocation and the second frequency allocation may be common to the first slot type and the second slot type.

Some examples of the method, apparatuses, and non-transitory computer-readable medium described herein may further include operations, features, means, or instructions for selecting the first frequency allocation for transmission of the first uplink message based on whether a start and length indicator for the first set of one or more slots may be of the first slot type or the second slot type.

Some examples of the method, apparatuses, and non-transitory computer-readable medium described herein may further include operations, features, means, or instructions for receiving downlink control information indicating one of the first frequency allocation for transmitting the first uplink message via the first set of one or more slots or a second frequency allocation for transmitting a second uplink message via the second set of one or more slots.

In some examples of the method, apparatuses, and non-transitory computer-readable medium described herein, a first resource block of the first set of one or more slots may be associated with an uplink subband from the second set of one or more slots based on a correlation between a position of the first resource block of the second set of one or more slots with respect to the second set of one or more slots and a position of a first resource block of the first set of one or more slots with respect to the first set of one or more slots.

Some examples of the method, apparatuses, and non-transitory computer-readable medium described herein may further include operations, features, means, or instructions for mapping a second frequency allocation to the first set of one or more slots based on adding one or more resource blocks to an uplink subband of the first set of one or more slots, where the first set of one or more slots and the second set of one or more slots may have a common first resource block.

In some examples of the method, apparatuses, and non-transitory computer-readable medium described herein, receiving the indication of the first frequency allocation may include operations, features, means, or instructions for receiving downlink control information signaling the first frequency allocation.

Some examples of the method, apparatuses, and non-transitory computer-readable medium described herein may further include operations, features, means, or instructions for receiving downlink control information indicating one or more of: an offset with respect to a quantity of resource blocks or a quantity of subbands, a restriction of the first set of one or more slots or the second set of one or more slots, an increase in a quantity of resource blocks or a quantity of subbands for the first set of one or more slots, or any combination thereof.

In some examples of the method, apparatuses, and non-transitory computer-readable medium described herein, the first frequency allocation may be associated with a first modulation and coding scheme and a second frequency allocation may be associated with a second modulation and coding scheme.

In some examples of the method, apparatuses, and non-transitory computer-readable medium described herein, transmitting the first uplink message may include operations, features, means, or instructions for transmitting the first uplink message via the second set of one or more slots using a second frequency allocation based on the second set of one or more slots including at least one slot of the first slot type and at least one slot of the second slot type.

A method for wireless communication at a network entity is described. The method may include transmitting an indication of a first frequency allocation associated with a first slot type for a CG, receiving a first uplink message via a first set of one or more slots associated with the CG using the first frequency allocation based on the first set of one or more slots being of the first slot type, and cancelling a use of the first frequency allocation for receiving via a second set of one or more slots associated with the CG based on the second set of one or more slots being of a second slot type that is different from the first slot type.

An apparatus for wireless communication at a network entity is described. The apparatus may include at least one processor, and memory coupled (e.g., operatively, communicatively, functionally, electronically, or electrically) with the at least one processor, the memory storing instructions executable by the at least one processor (e.g., directly, indirectly, after pre-processing, without pre-processing) to cause the network entity to transmit an indication of a first frequency allocation associated with a first slot type for a CG, receive a first uplink message via a first set of one or more slots associated with the CG using the first frequency allocation based on the first set of one or more slots being of the first slot type, and cancel a use of the first frequency allocation for receiving via a second set of one or more slots associated with the CG based on the second set of one or more slots being of a second slot type that is different from the first slot type.

Another apparatus for wireless communication at a network entity is described. The apparatus may include means for transmitting an indication of a first frequency allocation associated with a first slot type for a CG, means for receiving a first uplink message via a first set of one or more slots associated with the CG using the first frequency allocation based on the first set of one or more slots being of the first slot type, and means for cancelling a use of the first frequency allocation for receiving via a second set of one or more slots associated with the CG based on the second set of one or more slots being of a second slot type that is different from the first slot type.

A non-transitory computer-readable medium storing code for wireless communication at a network entity is described. The code may include instructions executable by at least one processor (e.g., directly, indirectly, after pre-processing, without pre-processing) to transmit an indication of a first frequency allocation associated with a first slot type for a CG, receive a first uplink message via a first set of one or more slots associated with the CG using the first frequency allocation based on the first set of one or more slots being of the first slot type, and cancel a use of the first frequency allocation for receiving via a second set of one or more slots associated with the CG based on the second set of one or more slots being of a second slot type that is different from the first slot type.

Some examples of the method, apparatuses, and non-transitory computer-readable medium described herein may further include operations, features, means, or instructions for transmitting an indication of a second frequency allocation associated with the second slot type for the CG and receiving a second uplink message via the second set of one or more slots associated with the CG using the second frequency allocation based on the second set of one or more slots being of the second slot type.

In some examples of the method, apparatuses, and non-transitory computer-readable medium described herein, the first slot type may be a SBFD slot type and the second slot type may be a HD slot type, or where the first slot type may be the HD slot type and the second slot type may be the SBFD slot type.

In some examples of the method, apparatuses, and non-transitory computer-readable medium described herein, the first frequency allocation may be mapped to an uplink subband of the second set of one or more slots based on an offset between the uplink subband and the first set of one or more slots.

In some examples of the method, apparatuses, and non-transitory computer-readable medium described herein, the uplink subband may be offset from the first set of one or more slots by a quantity of resource blocks, a quantity of subbands, or both.

Some examples of the method, apparatuses, and non-transitory computer-readable medium described herein may further include operations, features, means, or instructions for transmitting downlink control information indicating one of the first frequency allocation for transmitting the first uplink message via the first set of one or more slots or a second frequency allocation for transmitting a second uplink message via the second set of one or more slots.

In some examples of the method, apparatuses, and non-transitory computer-readable medium described herein, the first frequency allocation and a second frequency allocation may be common to the first slot type and the second slot type.

In some examples of the method, apparatuses, and non-transitory computer-readable medium described herein, a first resource block of the first set of one or more slots may be associated with an uplink subband from the second set of one or more slots based on a correlation between a position of the first resource block of the second set of one or more slots with respect to the second set of one or more slots and a position of a first resource block of the first set of one or more slots with respect to the first set of one or more slots.

In some examples of the method, apparatuses, and non-transitory computer-readable medium described herein, a second frequency allocation may be mapped to the first set of one or more slots based on one or more resource blocks being added to an uplink subband of the first set of one or more slots, where the first set of one or more slots and the second set of one or more slots may have a common first resource block.

In some examples of the method, apparatuses, and non-transitory computer-readable medium described herein, transmitting the indication of the first frequency allocation may include operations, features, means, or instructions for transmitting downlink control information signaling the first frequency allocation.

Some examples of the method, apparatuses, and non-transitory computer-readable medium described herein may further include operations, features, means, or instructions for transmitting downlink control information indicating one or more of: an offset with respect to a quantity of resource blocks or a quantity of subbands, a restriction of the first set of one or more slots or the second set of one or more slots, an increase in a quantity of resource blocks or a quantity of subbands for the first set of one or more slots, or any combination thereof.

In some examples of the method, apparatuses, and non-transitory computer-readable medium described herein, the first frequency allocation may be associated with a first modulation and coding scheme and a second frequency allocation may be associated with a second modulation and coding scheme.

In some examples of the method, apparatuses, and non-transitory computer-readable medium described herein, receiving the first uplink message may include operations, features, means, or instructions for receiving the first uplink message via the second set of one or more slots using a second frequency allocation based on the second set of one or more slots including at least one slot of the first slot type and at least one slot of the second slot type.

### BRIEF DESCRIPTION OF THE DRAWINGS

FIG. 1 shows an example of a wireless communications system that supports subband full-duplex (SBFD) communications based on multiple uplink shared channel occasions in a configured grant period in accordance with one or more aspects of the present disclosure.

FIG. 2 shows an example of a wireless communications system that supports SBFD communications based on multiple uplink shared channel occasions in a configured grant period in accordance with one or more aspects of the present disclosure.

FIGS. 3 through 6 show examples of resource configurations that support SBFD communications based on multiple uplink shared channel occasions in a configured grant period in accordance with one or more aspects of the present disclosure.

FIG. 7 shows an example of a process flow that supports SBFD communications based on multiple uplink shared channel occasions in a configured grant period in accordance with one or more aspects of the present disclosure.

FIGS. 8 and 9 show block diagrams of devices that support SBFD communications based on multiple uplink shared channel occasions in a configured grant period in accordance with one or more aspects of the present disclosure.

FIG. 10 shows a block diagram of a communications manager that supports SBFD communications based on multiple uplink shared channel occasions in a configured grant period in accordance with one or more aspects of the present disclosure.

FIG. 11 shows a diagram of a system including a device that supports SBFD communications based on multiple uplink shared channel occasions in a configured grant period in accordance with one or more aspects of the present disclosure.

FIGS. 12 and 13 show block diagrams of devices that support SBFD communications based on multiple uplink shared channel occasions in a configured grant period in accordance with one or more aspects of the present disclosure.

FIG. 14 shows a block diagram of a communications manager that supports SBFD communications based on multiple uplink shared channel occasions in a configured grant period in accordance with one or more aspects of the present disclosure.

FIG. 15 shows a diagram of a system including a device that supports SBFD communications based on multiple uplink shared channel occasions in a configured grant period in accordance with one or more aspects of the present disclosure.

FIGS. 16 through 20 show flowcharts illustrating methods that support SBFD communications based on multiple uplink shared channel occasions in a configured grant period in accordance with one or more aspects of the present disclosure.

### DETAILED DESCRIPTION

In some wireless communications systems, some wireless devices (e.g., a user equipment (UE), a network entity, a base station) may implement full-duplex (FD) communications, allowing for simultaneous transmission and reception of signals. In some cases, the wireless devices may implement subband full-duplex (SBFD) communications allowing for simultaneous transmission and reception of signals on a subband-basis. That is, a network entity may receive signals via uplink subbands and transmit signals via downlink subbands, simultaneously. In some examples, SBFD communications may occur during slots of an SBFD slot type and half-duplex (HD) communications may occur during slots of an HD slot type.

A wireless device may receive an indication of a configured grant (CG) occasion via which the wireless device may transmit uplink messages (e.g., via a physical uplink shared channel (PUSCH)). In such cases, a CG may include multiple CG occasions (e.g., may indicate multiple slots for uplink transmissions), which may include both half-duplex (HD) and SBFD slot types, and a UE may transmit a PUSCH during each occasion.

However, the wireless communications system may lack support for allocating frequency resources in a CG with multiple types of slots. For example, a CG may indicate a set of resource blocks to be used by the UE to perform PUSCH transmissions over the slots indicated by the CG. In some examples, however, the set of resource blocks may not be entirely available for uplink transmissions in an SBFD slot type (e.g., a portion of the set of resource blocks indicated for PUSCH in the CG may fall within downlink subbands of one or more of SBFD slots indicated by the CG). In some such examples, the size of the PUSCH (e.g., a quantity of resource blocks occupied by the PUSCH) may be reduced to fit within an uplink subband of an SBFD slot of the CG according to control signaling. In such examples, limiting the amount of resources allocated to a CG based on the available uplink subbands of the SBFD slots may prevent the usage of additional resources available for transmitting the PUSCH in uplink HD slots of the CG. In some other examples, where the PUSCH resource allocation for a CG may be based on the PUSCH bandwidth available in HD slots, the resource blocks allocated to the CG may be unavailable for PUSCH transmission during an SBFD.

Various aspects of the present disclosure describe techniques for supporting multiple PUSCH occasions in a single CG for HD and SBFD communication. A UE may receive signaling indicating a CG for uplink transmissions (e.g., via a PUSCH) and the CG may include both HD and SBFD slots. The UE may receive an indication of a first frequency resource allocation applicable to a first slot type (e.g., one of an HD slot type or an SBFD slot type) for the CG. In addition, the UE may receive an indication of a second frequency resource allocation associated with a second slot type (e.g., the other of the HD slot type or the SBFD slot type), where the first and second slot types are different. The second frequency resource allocation may be explicitly signaled or may be implicitly signaled with reference to the first frequency resource allocation. The UE may transmit a first uplink message via a first set of slots using the first frequency resource allocation given that the first set of slots are of the first slot type. Accordingly, the UE may refrain from using or cancel use of the first frequency allocation for transmitting an uplink message via a second set of slots of the second slot type. Additionally, or alternatively, the UE may transit a second uplink message via the second set of slots and using the second frequency resource allocation based on the second set of slots being of the second slot type.

Aspects of the disclosure are initially described in the context of wireless communications systems. Aspects of the disclosure are additionally illustrated with reference to resource configurations and process flows. Aspects of the disclosure are further illustrated by and described with reference to apparatus diagrams, system diagrams, and flowcharts that relate to SBFD communications based on multiple uplink shared channel occasions in a configured grant period.

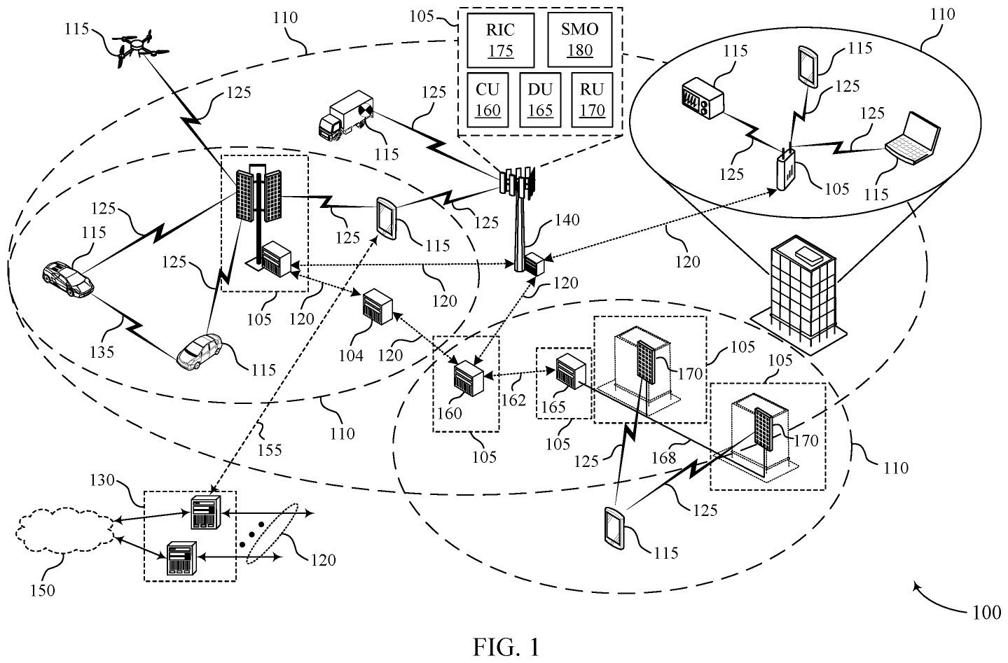

FIG. 1 shows an example of a wireless communications system 100 that supports SBFD communications based on multiple uplink shared channel occasions in a configured grant period in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support SBFD communications based on multiple uplink shared channel occasions in a configured grant period as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a multimedia/entertainment device (e.g., a radio, a MP3 player, or a video device), a camera, a gaming device, a navigation/positioning device (e.g., GNSS (global navigation satellite system) devices based on, for example, GPS (global positioning system), Beidou, GLONASS, or Galileo, or a terrestrial-based device), a tablet computer, a laptop computer, a netbook, a smartbook, a personal computer, a smart device, a wearable device (e.g., a smart watch, smart clothing, smart glasses, virtual reality goggles, a smart wristband, smart jewelry (e.g., a smart ring, a smart bracelet)), a drone, a robot/robotic device, a vehicle, a vehicular device, a meter (e.g., parking meter, electric meter, gas meter, water meter), a monitor, a gas pump, an appliance (e.g., kitchen appliance, washing machine, dryer), a location tag, a medical/healthcare device, an implant, a sensor/actuator, a display, or any other suitable device configured to communicate via a wireless or wired medium. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. In an aspect, techniques disclosed herein may be applicable to MTC or IoT UEs. MTC or IoT UEs may include MTC/enhanced MTC (eMTC, also referred to as CAT-M, Cat M1) UEs, NB-IoT (also referred to as CAT NB1) UEs, as well as other types of UEs. eMTC and NB-IoT may refer to future technologies that may evolve from or may be based on these technologies. For example, eMTC may include FeMTC (further eMTC), eFeMTC (enhanced further eMTC), and mMTC (massive MTC), and NB-IoT may include eNB-IoT (enhanced NB-IoT), and FeNB-IoT (further enhanced NB-IoT).

Some UEs 115 may be configured to employ operating modes that reduce power consumption, such as HD communications (e.g., a mode that supports one-way communication via transmission or reception, but not transmission and reception concurrently). In some examples, HD communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 capable of supporting HD operations may receive signaling indicating a CG for uplink transmissions (e.g., via a PUSCH) and the CG may include both HD and SBFD slots. The UE 115 may receive an indication of a first frequency resource allocation applicable to a first slot type for the CG (e.g., HD slots or SBFD slots). In addition, the UE 115 may receive an indication of a second frequency resource allocation associated with a second slot type (e.g., HD slots or SBFD slots), where the first and second slot types are different. The second frequency resource allocation may be explicitly signaled or may be implicitly signaled with reference to the first frequency resource allocation. The UE may transmit a first uplink message via a first set of slots using the first frequency resource allocation given that the first set of slots are of the first slot type. Accordingly, the UE 115 may refrain from using or cancel use of the first frequency allocation for transmitting an uplink message via a second set of slots of the second slot type. Additionally, or alternatively, the UE 115 may transit a second uplink message via the second set of slots and using the second frequency resource allocation based on the second set of slots being of the second slot type.

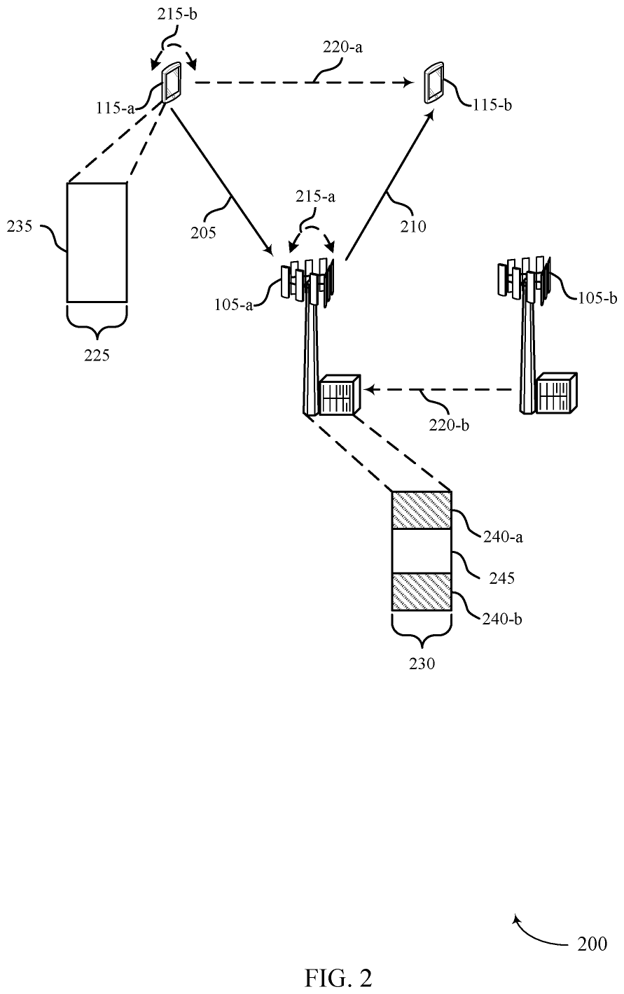

FIG. 2 shows an example of a wireless communications system 200 that supports SBFD communications based on multiple uplink shared channel occasions in a configured grant period in accordance with one or more aspects of the present disclosure. The wireless communication system may include a network entity 105-a, a network entity 105-b, a UE 115-a, and a UE 115-b, which may be examples of corresponding devices as described herein, including with reference to FIG. 1. The UE 115-a may communicate with the network entity 105-a via cellular communication link 205 (e.g., a Uu link), and the UE 115-b may communicate with the network entity 105-a via cellular communication link 210 (e.g., a Uu link). In some cases, the UE 115-a and the network entity 105-a may perform uplink communications, and the UE 115-b and the network entity 105-a may perform downlink communications. Alternatively, the UE 115-a and the network entity 105-a may perform downlink communications, and the UE 115-b and the network entity 105-a may perform uplink communications.

In some implementations, the network entity 105-a may support FD operations (the simultaneous transmission and reception of signals) including SBFD operations, and the UEs 115 may support HD operations (the transmission or reception of signals at a given time). In SBFD operations, the bandwidth allocated to uplink transmissions and the bandwidth allocated to downlink transmissions may be non-overlapping within a slot.

In some other implementations, the network entity 105-a, the UE 115-a, and the UE 115-b may all support FD operations. In FD operations, the bandwidth allocated to uplink transmissions and the bandwidth allocated to downlink transmissions may partially or fully overlap within a slot. In yet some other implementations, the network entity 105-a, the network entity 105-b, and the UE 115-b may support HD operations, and the UE 115-a may support SBFD operations. In some cases, when performing FD operations (e.g., SBFD or FD operations), the network entity 105-a may experience self-interference (SI) 215-a. Additionally, or alternatively, the UE 115-b may experience CLI 220-a from the UE 115-a, and the network entity 105-a may experience cross-link interference (CLI) 220-b from the network entity 105-b. In some implementations where the UE 115-a is operating in FD (e.g., SBFD or FD), the UE 115-a may experience SI 215-b.

The UEs 115 and the network entity 105-a may perform communications based on a CG. The CG may be configured with multiple occasions for transmitting one or more PUSCHs. For example, the CG may be configured with a quantity of allocated slots within a CG periodicity. In some cases, where the wireless communications system 200 may include both HD devices and FD devices, the CG may be configured with both HD slots 225 and SBFD slots 230. For instance, in the example of FIG. 2, the UE 115-a may be associated with the HD slot 225, and the network entity 105-a may be associated with the SBFD slot 230. The HD slot 225 may include a frequency band 235, which may be an uplink band or a downlink band. The SBFD slot 230 may include one or more subbands, which may be examples of downlink subbands 240-a and 240-b, and uplink subband 245.

Each slot of the CG may be further configured with a quantity of consecutive PUSCH occasions and multiple frequency resource allocations for transmission and reception of the PUSCHs. In some cases, where the wireless communications system 200 may include both HD devices and FD devices, each of the multiple frequency resource allocations may be associated with a slot type. For example, the CG may be configured with a first frequency resource allocation corresponding to an HD slot and a second frequency resource allocation corresponding to the SBFD slot 225. That is, multiple frequency resource allocations (e.g., frequencyDomainAllocation) entries may be present in a CG information element (e.g., ConfiguredGrantConfiguration) to distinguish PUSCH allocations that may have different allocations in the frequency domain. In some cases, the first frequency resource allocation and the second frequency resource allocation may be different (e.g., correspond to different slot types). In some other cases, the first frequency resource allocation and the second frequency resource allocation may be the same (e.g., correspond to a same slot type).

In some cases, where the wireless communications system 200 may include both HD devices and FD devices, the CG may be configured with multiple modulation and coding schemes (MCSs). In such cases, each MCSs may correspond to a slot type. For example, the CG may be configured with a first MCS corresponding to an HD slot 225 and a second MCS corresponding to an SBFD slot 230. Additionally, or alternatively, the HD slot 225 may be associated with a first transport block size (TBS) and the SBFD slot 230 may be associated with a second TBS.

The CG may be a Type 1 CG or a Type 2 CG. In some cases, where the UEs 115 and the network entity 105-a may communicate according to a Type 2 CG, the UE 115-b may activate the Type 2 CG based on receiving control signaling (e.g., downlink control information (DCI)) from the network entity 105-a. The control signaling may further include additional frequency resource allocation information, including the second frequency resource allocation, an increase in a quantity of resource blocks or subbands for transmitting a PUSCH, an offset in a quantity of resource blocks or subbands for transmitting a PUSCH, a restriction applicability, or any combination thereof.

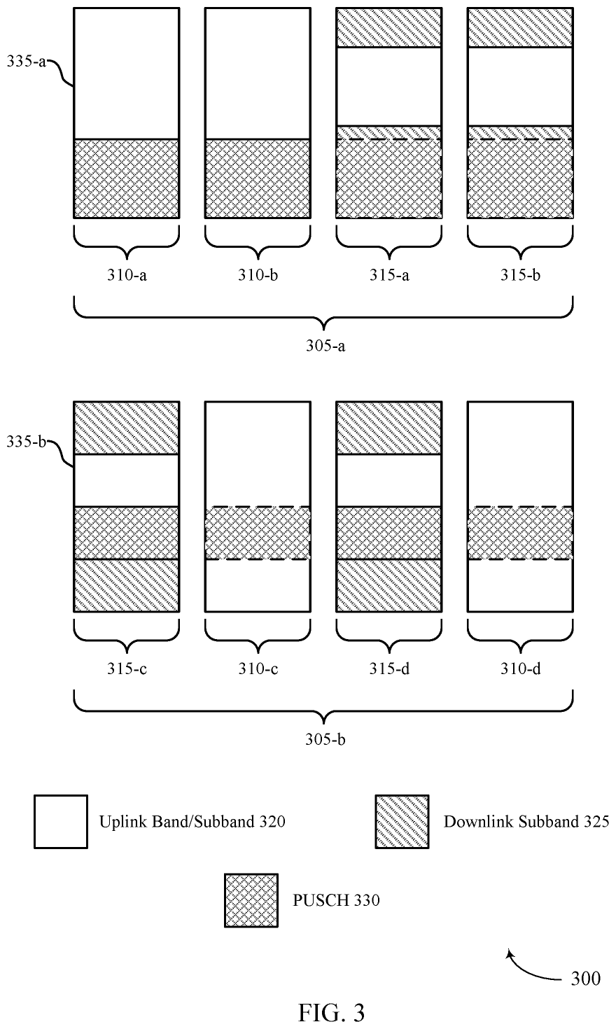

FIG. 3 shows an example of a resource configuration 300 that supports SBFD communications based on multiple uplink shared channel occasions in a configured grant period in accordance with one or more aspects of the present disclosure. The resource configuration 300 may be implemented by aspects of the wireless communications system 100 and the wireless communications system 200 as described with reference to FIGS. 1 and 2. For instance, in the example of FIG. 3, UEs and a network entity may perform communications according to a CG 305, which may be examples of corresponding devices and configurations as described herein, including with reference to FIGS. 1 and 2. For example, a wireless node (e.g., a UE, a network entity, or both) may configure the CG 305 with multiple PUSCH occasions including one or more HD slots 310, one or more SBFD slots 315, or any combination thereof. The HD slots 310 may each include a single band in the frequency domain, which may be an uplink band. The SBFD slots 315 may each include one or more frequency subbands, including one or more uplink subbands 320 and one or more downlink subbands 325.

In some examples, the network entity may further configure the CG 305 with multiple frequency resource allocations for transmission and reception of one or more PUSCHs 330, and each of the multiple frequency resource allocations may be associated with a slot type. For example, the network entity may configure a CG 305-a with a first frequency resource allocation corresponding to the HD slots 310 (including an HD slot 310-a and an HD slot 310-b) and a second frequency resource allocation corresponding to the SBFD slots 315 (including an SBFD 315-a and an SBFD 315-b), and may configure a CG 305-b with a first frequency resource allocation corresponding to the SBFD slots 315 (including an SBFD slot 315-c and an SBFD slot 315-d) and a second frequency resource allocation corresponding to the HD slots 310 (an HD slot 310-c and an HD slot 310-d). In some cases, the network entity, a UE, or both may determine to refrain from transmitting the PUSCH 330 over a slot. In some implementations, multiple UEs and multiple network entities may perform communications according to a CG 305, and at least one of the multiple UEs, at least one of the multiple network entities, or any combination thereof, may determine to refrain from transmitting the PUSCH 330.

In some examples, the UE or the network entity may cancel the PUSCH 330 based on a slot type associated with a slot in which an uplink message is being transmitted and received. In such examples, the UE may cancel the PUSCH 330 by invalidating the HD slots 310 or the SBFD slots 315 containing the PUSCH 330, dropping the HD slots 310 or the SBFD slots 315 containing the PUSCH 330, or by considering the HD slots 310 or the SBFD slots 315 as an error case, based on determining whether the first slot 335-a of the CG 305-a is an SBFD slot 315 or an HD slot 310, respectively. For example, the UE may cancel the transmission of the PUSCH 330 during SBFD slots 315 based on a first slot 335-a of the CG 305-a being an HD slot 310 (specifically, an HD slot 310-a).

In some cases, based on the first slot 335-a of the CG 305-a being an HD slot 310, the second frequency resource allocation associated with the SBFD slots 315 may be determined based on a first frequency resource allocation associated with the HD slots 310. For example, the first frequency resource allocation associated with the HD slots 310 and the second frequency resource allocation associated with the SBFD slots 315 may be the same. In such cases, the frequency resources allocated for the PUSCH 330 associated with the SBFD slots 315 may be non-overlapping with an uplink subband 320 of the SBFD slot 315. Alternatively, in some implementations, the CG 305 may be associated with one frequency resource allocation associated with both the HD slots 310 and the SBFD slots 315. In such implementations, the frequency resources allocated for the PUSCH 330 associated with the SBFD slots 315 may be non-overlapping with an uplink subband 320 of the SBFD slot 315.

In some cases, during a period of a CG 305 with multiple PUSCH occasions with slots that may include both HD slots 310 and SBFD slots 315, the network entity may restrict the frequency resource allocation (e.g., frequencyDomainAllocation) for the PUSCH 330 to the HD slots 310 (e.g., TDD HD slots). Alternatively, the network entity may restrict the frequency resource allocation (e.g., frequencyDomainAllocation) for the PUSCH 330 to the SBFD slots 315.

In some other examples, the network entity may restrict allocating the PUSCH 330 based on slot type. In such examples, the wireless node may determine to restrict (e.g., selectively allocate) frequency resources for transmitting the PUSCH 330 to the HD slots 310 or the SBFD slots 315 based on an indication of a PUSCH 330 to be transmitted in a first slot 335 (e.g., a first PUSCH 330) included in a Start and Length Indicator Value (SLIV). The first PUSCH 330 in which the SLIV is described (indicated) may further indicate whether the first slot 335-b of the CG 305-b is an HD slot 310 or an SBFD slot 315.

In such cases, the network entity may restrict the PUSCH 330 transmission based on the SBFD slots 315 if the first slot 335-b is an SBFD slot 315 or based on the HD slots 310 if the first slot 335-b is an HD slot 310. For example, in the case of the CG 305-b, the network entity may determine to use a second frequency resource allocation associated with SBFD slots 315 for the CG 305-b based on determining whether a first slot 335-b of the CG 305-b is an SBFD slot 315-c. In some cases, based on the first slot 335-b of the CG 305-b being an SBFD slot 315, the network entity may refrain from allocating frequency resources for transmitting the PUSCH 330 to the HD slots 310. Alternatively, in the case of CG 305-a, the network entity may determine to use a first frequency resource allocation associated with the HD slots 310 based on the first slot 335-a of the CG 305-a being an HD slot 310-a and may refrain from allocating frequency resources for transmitting the PUSCH 330 to the SBFD slots 315.

In some cases, where the CG 305 is a Type 2 CG, control signaling (e.g., DCI) activating the CG 305 may indicate a slot type to restrict allocating the PUSCH 330 to. For example, to determine which of the slots in a CG 305 the network entity may restrict the PUSCH 330 to, the control signaling may explicitly indicate whether the CG 305 is applicable to the HD slots 310 or the SBFD slots 315. That is, the network entity may restrict allocating the PUSCH 330 to HD slots 310 (e.g., may refrain from allocating the PUSCH 330 to the SBFD slots 315) or to SBFD slots 315 (e.g., may refrain from allocating the PUSCH 330 to the HD slots 310).

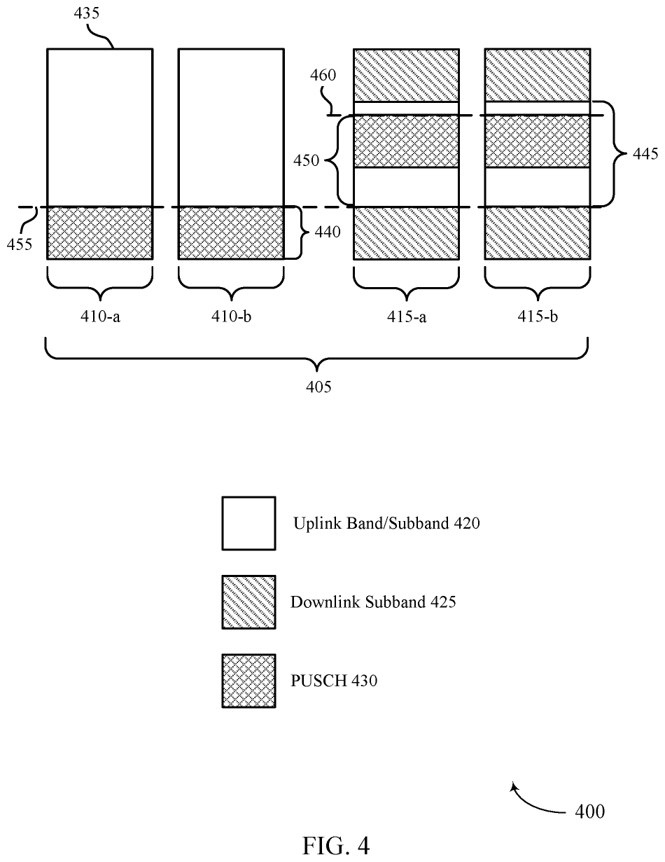

FIG. 4 shows an example of a resource configuration 400 that supports SBFD communications based on multiple uplink shared channel occasions in a configured grant period in accordance with one or more aspects of the present disclosure. The resource configuration 400 may be implemented by aspects of the wireless communications system 100 and the wireless communications system 200 as described with reference to FIGS. 1 and 2. For instance, in the example of FIG. 4, wireless nodes (e.g., UEs, network entities, or any combination thereof) may perform communications according to a CG 405, which may be examples of corresponding devices and configurations as described herein, including with reference to FIGS. 1 and 2. For example, the CG 405 may be associated with multiple PUSCH occasions, including one or more HD slots 410, one or more SBFD slots 415, or any combination thereof. The HD slots 410 may each include a single band, which may be an uplink band. The SBFD slots 415 may each include one or more frequency subbands, including one or more uplink subbands 420 and one or more downlink subbands 425.

The CG 405 may include HD slots 410 (including an HD slot 410-a and an HD slot 410-b) followed by SBFD slots 415 (including an SBFD slot 415-a and an SBFD slot 415-b). In some cases, a network entity may configure the CG 405 with one frequency resource allocation associated with both the HD slots 410 and the SBFD slots 415. The frequency resource allocation may be associated with the type of a first slot 435 of the CG 405. For example, the frequency resource allocation may be associated with HD slots 410 based on the first slot 435 of the CG 405 being an HD slot 410-a. Alternatively, the frequency resource allocation may be associated with SBFD slots 415 based on the first slot 435 of the CG 405 being an SBFD slot 415. In some other cases, the network entity may further configure the CG 405 with multiple frequency resource allocations for transmission and reception of one or more PUSCHs 430, and each of the multiple frequency resource allocations may be associated with a slot type. For example, the CG 405 may be associated with a first frequency resource allocation corresponding to the HD slots 410 and a second frequency resource allocation corresponding to the SBFD slots 415. Alternatively, the CG 405 may be associated with a first frequency resource allocation corresponding to the SBFD slots 415 and a second frequency resource allocation corresponding to the HD slots 410.

In some examples, the first slot 435 of the CG 405 may be an HD slot 410-a. In such examples, based on the first slot 435 of the CG 405 being an HD slot 410, the network entity may configure the CG 405 with a frequency resource allocation corresponding to the HD slots 410. The network entity may map the frequency resource allocation to an uplink subband 420 of an SBFD slot 415 within the CG 405 to accommodate the SBFD slots 415 within the CG 405. The network entity may allocate PUSCH 430 on the HD slots 410 in accordance with the frequency resource allocation and the SBFD slots 415 in accordance with the mapped frequency resource allocation. In some cases, the PUSCH 430 may fit within the one or more uplink subbands 420. For example, the size 440 (in terms of a frequency allocation) of the PUSCH 430 may be less than or equal to the size 445 of the uplink subband 420. In such cases, the network entity may apply an offset value 450 (in terms of a frequency allocation) to the mapped frequency allocation. The offset value 450 may be a quantity of resource blocks (RBs), a quantity of subbands, or both.

Alternatively, the CG 405 may be associated with a first frequency resource allocation corresponding to the HD slots 410 and a second frequency resource allocation corresponding to the SBFD slots 415. In some examples, the size of the first frequency resource allocation and the size of the second frequency resource allocation may be the same (e.g., PUSCHs 430 transmitted in HD slots 410 and SBFD slots 415 may be the same size 440, where the size 440 may represent a frequency allocation).

Additionally, the starting position of the first frequency allocation and the starting position of the second frequency allocation may be the same (e.g., PUSCHs 430 transmitted in SBFD slots 415 may begin at a same respective starting resource block 455 of HD slots 410). In some cases, the PUSCH 430 may fit within the one or more uplink subbands 420. For example, the size 440 of the PUSCH 430 may be less than or equal to the size 445 of the uplink subband 420. In such cases, the wireless node may apply an offset value 450 to the second frequency allocation. For example, the wireless node may shift PUSCHs 330 transmitted during SBFD slots 415 by the offset value 450. In some cases, the wireless node may shift the starting resource block 455 of the second frequency allocation by the offset value 450 to a resource block 460 of the SBFD slots 415.

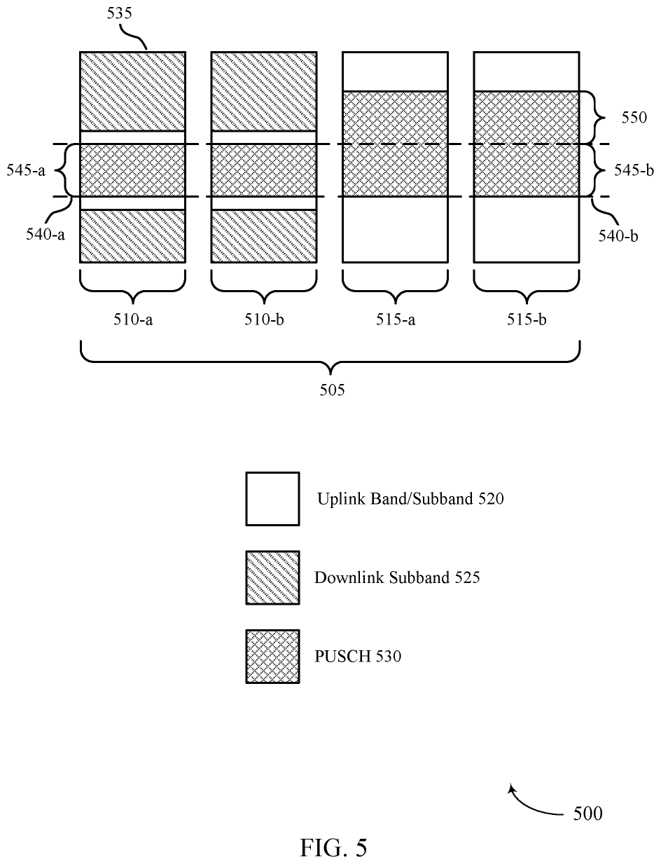

FIG. 5 shows an example of a resource configuration 500 that supports SBFD communications based on multiple uplink shared channel occasions in a configured grant period in accordance with one or more aspects of the present disclosure. The resource configuration 500 may be implemented by aspects of the wireless communications system 100 and the wireless communications system 200 as described with reference to FIGS. 1 and 2. For instance, in the example of FIG. 5, wireless nodes (e.g., UEs, network entities, or any combination thereof) may perform communications according to a CG 505, which may be examples of corresponding devices and configurations as described herein, including with reference to FIGS. 1 and 2. For example, the wireless node may configure the CG 505 with multiple occasions, including one or more SBFD slots 510, one or more HD slots 515, or any combination thereof. The SBFD slots 510 may each include one or more frequency subbands, including one or more uplink subbands 520 and one or more downlink subbands 525. The HD slots 515 may each include a single band in the frequency domain, which may be an uplink band.

The CG 505 may include SBFD slots 510 (including an SBFD slot 510-a and an SBFD slot 510-b) followed by HD slots 515 (including an HD slot 515-a and an HD slot 515-b). In some examples, the CG 505 may be associated with multiple frequency resource allocations for transmission and reception of one or more PUSCHs 530, and each of the multiple frequency resource allocations may be associated with a slot type. For example, the CG 505 may be associated with a first frequency resource allocation corresponding to the SBFD slots 510 and a second frequency resource allocation corresponding to the HD slots 515 based on a first slot 535 of the CG 505 being an SBFD slot 510-a. Alternatively, the CG 505 may be associated with a first frequency resource allocation corresponding to the HD slots 515 and a second frequency resource allocation corresponding to the SBFD slots 510. In some other examples, the CG 505 may be associated with one frequency resource allocation associated with both the SBFD slots 510 and the HD slots 515. The frequency resource allocation may be associated with the type of a first slot 535 of the CG 505. For example, the frequency resource allocation may be associated with SBFD slots 510 based on the first slot 535 of the CG 505 being an SBFD slot 510-a.

The network entity may allocate resources to the CG 505 according to an allocation type and the one or more frequency resource allocations. For example, the network entity may allocate resources for transmitting the PUSCH 530 according to a resource allocation time (RAT) Type 1 (e.g., allocate resources to one or more consecutive RBs). The resource allocation for a RAT Type 1 may be configured via control signaling (e.g., DCI), which may further indicate resource allocation parameters (e.g., a starting RB 540 and a quantity of consecutive RBs) via a Resource Indicator Value (RIV).

In some cases, where the CG 505 may be associated with a first frequency resource allocation and a second frequency resource allocation as described herein, the first frequency resource allocation and the second frequency resource allocation may be common (e.g., the first frequency resource allocation and the second frequency resource allocation may be the same), and the network may allocate resources for transmitting the PUSCH 530 based on a slot type of the slot in which the PUSCH 530 is transmitted. For example, the network entity may allocate the PUSCH 530 to the SBFD slots 510 according to the first frequency resource allocation and the HD slots 515 according to the second frequency allocation based on a first slot 535 of the CG 505 being an SBFD slot 510-a. In such examples, the network entity may interpret the parameters (e.g., the starting RB 540 and the quantity of consecutive RBs) associated with the first frequency resource allocation and the second frequency resource allocation differently based on slot type.

For instance, with respect to SBFD slots 510, the network entity may interpret the parameters associated with the first frequency resource allocation (which may be associated with the SBFD slots 510) based on the parameters associated with the second frequency resource allocation (which may be associated with the HD slots 515), and may allocate the PUSCH 530 to the SBFD slots 510 accordingly. For example, the network entity may allocate the PUSCH 530 to the SBFD slots 510 according to the starting RB 540-a and the quantity of consecutive RB (e.g., size 545-a). The network entity may interpret a starting RB 540-a associated with the SBFD slots 510 based on the one or more uplink subbands 520 reserved for transmitting the PUSCH 530 in the HD slots 515. In such examples, the starting RB 540-a of the PUSCH 530 associated with SBFD slots 510 may be the same as a starting RB 540-b of the PUSCH 530 associated with the HD slots 515.

In some cases, where the network entity may interpret the starting RB 540-a based on the starting RB 540-b, the PUSCH 530 may fall out of the one or more uplink subband 520 of the SBFD slots 510 (e.g., some RBs associated with the PUSCH 530 may overlap with a downlink subband 525). In such cases, the network entity may drop the resource blocks that are not within the one or more uplink subbands 520 of the SBFD slots 510. The network entity may further adjust the CG 505 so the PUSCH 530 is within the one or more uplink subbands 520 of the SBFD slots 510. Additionally, the quantity of consecutive RBs associated with the SBFD slots 510 (e.g., size 545-a of the PUSCH 530 associated with the SBFD slots 510) may be interpreted based on the quantity of consecutive resource blocks associated with the HD slots 515 (e.g., size 545-b of the PUSCH 530 associated with the HD slots 515). For example, the size 545-a of the PUSCH 530 associated with the SBFD slots 510 may be the same as the size 545-b of the PUSCH 530 associated with the HD slots 515. Additionally, or alternatively, with respect to HD slots 515, the network entity may interpret the parameters associated with the second frequency resource allocation (e.g., HD slots 515) and may allocate the PUSCH 530 to the HD slots 515 accordingly. For example, the network entity may allocate the PUSCH 530 to the HD slots 515 according to the starting RB 540-b and the size 545-b.

In some other cases, where the network entity may configure the CG 505 with one frequency resource allocation associated with a slot type, the network entity may map the frequency resource allocation to the other slot type. For example, the frequency resource allocation may be associated with SBFD slots 510 based on the first slot 535 of the CG 505 being an SBFD slot 510-a. In such examples, the network entity may map the frequency resource allocation to an uplink band of the HD slot 515 within the CG 505 to accommodate the HD slots 515 within the CG 505. The network entity may allocate the PUSCH 530 on the SBFD slots 510 in accordance with the frequency resource allocation and the HD slots 515 in accordance with the mapped frequency resource allocation. Additionally, the network entity may interpret the parameters (e.g., the starting RB 540 and the quantity of consecutive RBs) associated with the frequency resource allocation differently based on slot type.

For instance, with respect to HD slots 515, the network entity may interpret the parameters associated with the mapped frequency resource allocation (e.g., the HD slots 515) and may allocate the PUSCH 530 to the HD slots 515 accordingly. In some examples, the RIV may further include an additional parameter indicating a delta (e.g., an increase 550 in frequency) in the quantity of consecutive RBs associated with the HD slots 515. In such cases where the network entity may configure the CG 505 with one frequency resource allocation, the network entity may allocate the PUSCH 530 to the HD slots 515 according to the starting RB 540, the quantity of consecutive RBs (e.g., size 545), and the increase 550 in the quantity of consecutive RBs associated with the HD slots 515.

Additionally, or alternatively, with respect to the SBFD slots 510, the network entity may interpret the parameters associated with the frequency resource allocation (e.g., SBFD slots 510) and may allocate the PUSCH 530 to the SBFD slots 510 accordingly. For example, the network entity may allocate the PUSCH 530 to the SBFD slots 510 according to the starting RB 540 and the quantity of consecutive RBs (e.g., size 545). The starting RB 540 may be common (e.g., the same) between the SBFD slots 510 and the HD slots 515.

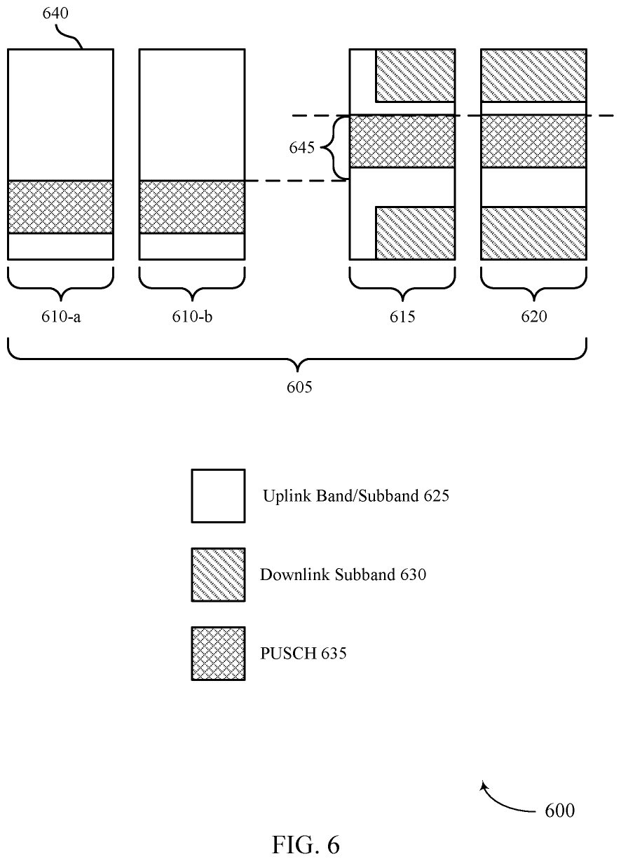

FIG. 6 shows an example of a resource configuration 600 that supports SBFD communications based on multiple uplink shared channel occasions in a configured grant period in accordance with one or more aspects of the present disclosure. The resource configuration 600 may be implemented by aspects of the wireless communications system 100 and the wireless communications system 200 as described with reference to FIGS. 1 and 2. For instance, in the example of FIG. 6, wireless nodes (e.g., UEs, network entities, or any combination thereof) may perform communications according to a CG 605, which may be examples of corresponding devices and configurations as described herein, including with reference to FIGS. 1 and 2. For example, the CG 605 may be associated with multiple occasions, including one or more HD slots 610, one or more FD slots 615 (e.g., non-SBFD slots), one or more SBFD slots 620, or any combination thereof. The HD slots 610 may each include a single frequency band, which may be an uplink band 625. The FD slots 615 may each include one or more overlapping frequency subbands, including one or more uplink subbands 625 and one or more downlink subbands 630 that may overlap (e.g., partially or fully) in both time and frequency.

The CG 605 may include HD slots 610 (including an HD slot 610-a and an HD slot 610-b) followed by an FD slot 615 and an SBFD slot 620. For example, a first slot 640 may be the HD slot 610-a. In some examples, a network node may configure a UE to transmit one or more PUSCHs 635 during multiple occasions of the CG 605. In such examples, the network entity may determine one or more frequency resource allocations associated with the CG 605 for transmitting the PUSCH 635 and may transmit the PUSCH 635 via the HD slots 610 and the SBFD slots 620 in accordance with techniques described herein. For example, the network entity may determine to apply an offset 645 to a mapped frequency resource offset associated with the SBFD slots 620 in accordance with procedures described herein with reference to FIG. 4.

In some examples, based on the CG 605 including both FD slots 615 and SBFD slots 620, the network entity may further determine to use the frequency resource allocation associated with the SBFD slots 620 (e.g., a first frequency resource allocation, a second frequency resource allocation, a mapped frequency resource allocation) for the FD slots 615, such that the network entity may allocate resources for transmitting the PUSCH 635 via the FD slots 615 within the CG 605. In such examples, the frequency resource allocation associated with the FD slots 615 and the frequency resource allocation associated with the SBFD slots 620 may be the same. The network entity may transmit the PUSCH 635 via the FD slots 615 based on the frequency resource allocation. The network entity may apply the offset 645 to the PUSCH 635 in both the FD slots 615 and the SBFD slots 620. In some other examples, based on determining that the CG 605 may include both the FD slots 615 and the SBFD slots 620, the network entity may drop or skip the transmission of the PUSCH 635.

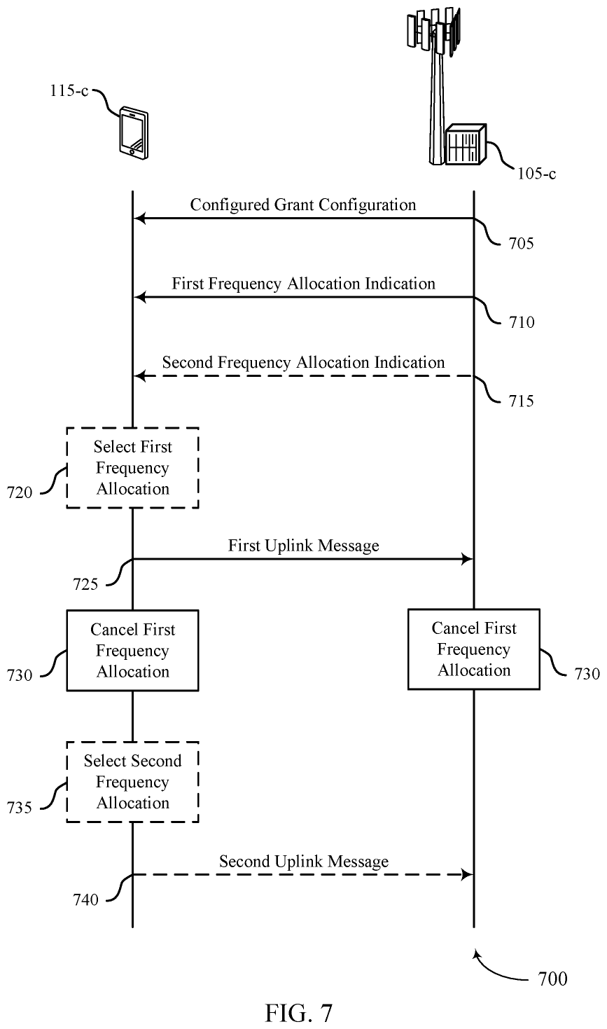

FIG. 7 shows an example of a process flow 700 that supports SBFD communications based on multiple uplink shared channel occasions in a configured grant period in accordance with one or more aspects of the present disclosure. The process flow 700 may implement or may be implemented by aspects of the wireless communications system 100 as described with reference to FIG. 1. For instance, in the example of FIG. 7, a UE 115-c may be in communication with a network entity 105-c. The UE 115-c may be an example of a UE 115, and the network entity 105-c may be an example of a network entity 105 as described with reference to FIG. 1. The UE 115-c may communicate with the network entity 105-c via a cellular communication link (e.g., uplink), which may be an example of a communication link 125 with respect to FIG. 1. The UE 115-c may be an example of an HD device (e.g., a wireless device capable of HD operation), and the network entity 105-c may be an example of an SBFD device (e.g., a wireless device capable of SBFD operation). In the following description of the process flow 700, the operations between the UE 115-c and the network entity 105-c may be transmitted in a different order than the example order shown, or the operations between the UE 115-c and the network entity 105-c may be performed in different orders at different times. Some operations may also be omitted from the process flow 700, and other operations may be added to the process flow 700.

At 705, the UE 115-c may receive an indication of a configuration for a CG, which may be an example of a CG as described herein with reference to FIGS. 3-6. In some examples, the network entity 105-c may indicate the CG configuration to the UE 115-c via RRC signaling. The CG may be associated with multiple occasions for transmitting uplink messages (e.g., PUSCH). In addition, the CG may be associated with multiple slot types, such as SBFD slots and HD slots. The CG may be associated with a quantity of time-frequency resources for transmitting the PUSCH and may indicate, to the UE 115-c, to transmit the PUSCH to the network entity 105-c during such resources. For example, the CG may be associated with a first frequency allocation that is associated with a first slot type, and in some cases, a second frequency allocation that is associated with a second slot type.

At 710, the UE 115-c may receive the indication of the first frequency allocation associated with a first slot type for a CG. The first slot type may be an SBFD slot type or an HD slot type. In some cases, the network entity 105-a may include the indication of the first frequency allocation via the indication of the CG configuration at 705 (e.g., via RRC signaling). In some other cases, the network entity 105-a may transmit the indication via control signaling (e.g., DCI). In some cases, the DCI may indicate one of the first frequency allocation for transmitting a first uplink message via the first set of one or more slots or a second frequency allocation for transmitting a second uplink message via a second set of one or more slots. In some cases, the DCI may indicate the first frequency allocation or the second frequency allocation as an offset with respect to a quantity of RBs or a quantity of subbands, a restriction of the first set of one or more slots or the second set of one or more slots, an increase in the quantity of RBs or the quantity of subbands for the first set of one or more slots, or any combination thereof.

In some examples, a first RB of the first set of one or more slots may be associated with an uplink subband from the second set of one or more slots based on a correlation between a position of the first RB of the second set of one or more slots with respect to the second set of one or more slots and a position of a first RB of the first set of one or more slots with respect to the first set of one or more slots. In some cases, the UE 115-c may map the first frequency allocation to the uplink subband of the second set of one or more slots based on applying the offset to the uplink subband with respect to the first set of one or more slots. In such cases, the uplink subband may be offset from the first set of one or more slots by the quantity of RBs, the quantity of subbands, or both.

At 715, the UE 115-c may receive the indication of the second frequency allocation associated with a second slot type for the CG from the network entity 105-c. In some cases, where the first slot type corresponds to SBFD slots, the second slot type may correspond to HD slots. In some other cases, where the first slot type corresponds to HD slots, the second slot type may correspond to SBFD slots. In some cases, the network entity 105-c may include the indication of the second frequency allocation via the indication of the CG configuration at 705 (e.g., via RRC signaling). In some other cases, the network entity 105-c may indicate the second frequency allocation via control signaling (e.g., DCI). In some examples, based on receiving the indication of the second frequency allocation, the UE 115-c may map the second frequency allocation to the first set of one or more slots based on adding one or more RBs to an uplink subband of the first set of one or more slots. In such examples, the first set of one or more slots and the second set of one or more slots may have a common first RB.

At 720, the UE 115-c may select the first frequency allocation for transmission of the first uplink message based on the first set of one or more slots being of the first slot type. The UE 115-c may further select the first frequency allocation for transmission of the first uplink message based on whether a SLIV for the first set of one or more slots is of the first slot type or the second slot type that is different from the first slot type.

At 725, the UE 115-c may transmit the first uplink message. In some cases, the UE 115-c may transmit the first uplink message via the first set of one or more slots associated with the CG using the first frequency allocation based on the first set of one or more slots being of the first slot type. In some other cases, the UE 115-c may transmit the first uplink message via the second set of one or more slots using the second frequency allocation based at least in part on the second set of one or more slots including at least one slot of the first slot type and at least one slot of the second slot type.

At 730, the UE 115-c may cancel a use of the first frequency allocation for transmitting via the second set of one or more slots associated with the CG based on the second set of one or more slots being of the second slot type. Additionally, or alternatively, the network entity 105-c may cancel a use of the first frequency allocation for receiving via the second set of one or more slots associated with the CG based on the second set of one or more slots being of the second slot type.

At 735, the UE 115-c may select the second frequency allocation for transmission of a second uplink message based on the second set of one or more slots being of the second slot type. In some cases, the first frequency allocation and the second frequency allocation may be common to the first slot type and the second slot type.

At 740, the UE 115-c may transmit the second uplink message via the second set of one or more slots associated with the CG using the second frequency allocation based on the second set of one or more slots being of the second slot type.

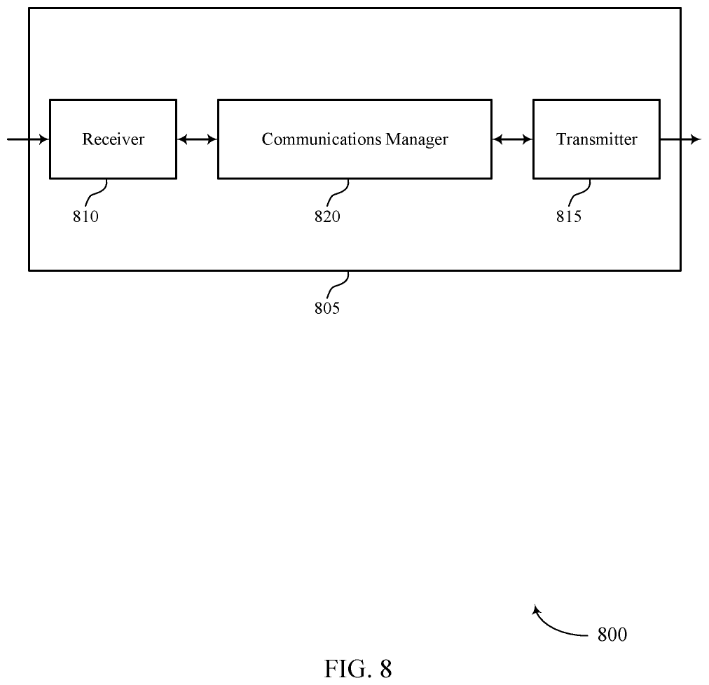

FIG. 8 shows a block diagram 800 of a device 805 that supports SBFD communications based on multiple uplink shared channel occasions in a configured grant period in accordance with one or more aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to SBFD communications based on multiple uplink shared channel occasions in a configured grant period). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SBFD communications based on multiple uplink shared channel occasions in a configured grant period). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of SBFD communications based on multiple uplink shared channel occasions in a configured grant period SBFD as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), a central processing unit (CPU), a graphics processing unit (GPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 820, the receiver 810, the transmitter 815, or various combinations or components thereof may be implemented in hardware, software (e.g., executed by a processor), or any combination thereof. If implemented in code executed by a processor, the functions of the communications manager 820, the receiver 810, the transmitter 815, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE in accordance with examples as disclosed herein. For example, the communications manager 820 is capable of, configured to, or operable to support a means for receiving an indication of a first frequency allocation associated with a first slot type for a configured grant. The communications manager 820 is capable of, configured to, or operable to support a means for transmitting a first uplink message via a first set of one or more slots associated with the configured grant using the first frequency allocation based on the first set of one or more slots being of the first slot type. The communications manager 820 is capable of, configured to, or operable to support a means for cancelling a use of the first frequency allocation for transmitting via a second set of one or more slots associated with the configured grant based on the second set of one or more slots being of a second slot type that is different from the first slot type.

By including or configuring the communications manager 820 in accordance with examples as described herein, the device 805 (e.g., a processor controlling or otherwise coupled with the receiver 810, the transmitter 815, the communications manager 820, or a combination thereof) may support techniques for SBFD communications based on multiple uplink shared channel (e.g., PUSCH) occasions in a CG period, which may result in a more efficient utilization of communication resources, improved data throughput, improved communications between wireless devices, and reduced latency.

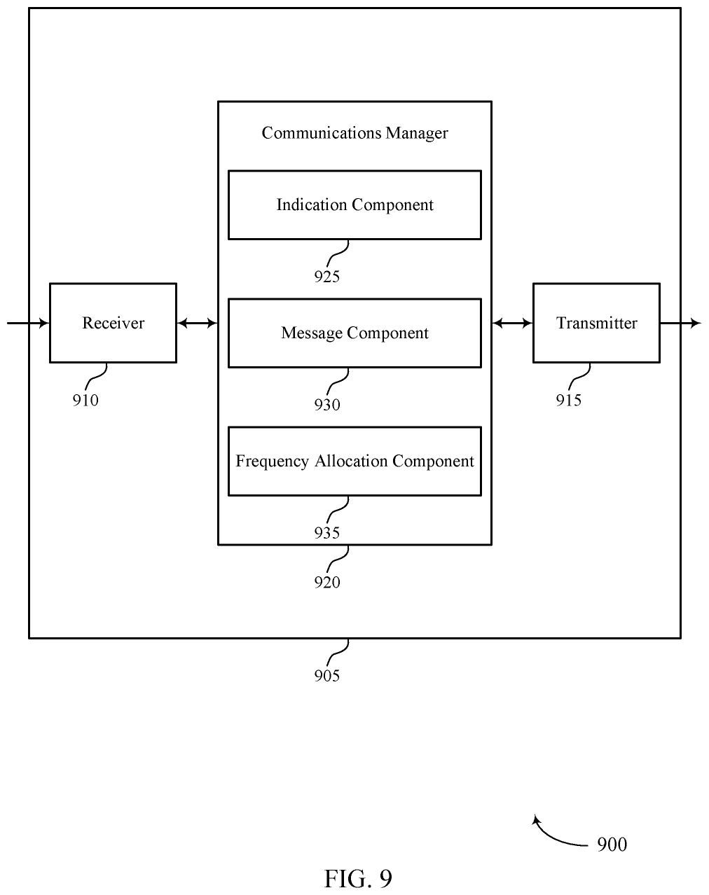

FIG. 9 shows a block diagram 900 of a device 905 that supports SBFD communications based on multiple uplink shared channel occasions in a configured grant period SBFD in accordance with one or more aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to SBFD communications based on multiple uplink shared channel occasions in a configured grant period). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to SBFD communications based on multiple uplink shared channel occasions in a configured grant period). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of SBFD communications based on multiple uplink shared channel occasions in a configured grant period SBFD as described herein. For example, the communications manager 920 may include an indication component 925, a message component 930, a frequency allocation component 935, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communication at a UE in accordance with examples as disclosed herein. The indication component 925 is capable of, configured to, or operable to support a means for receiving an indication of a first frequency allocation associated with a first slot type for a configured grant. The message component 930 is capable of, configured to, or operable to support a means for transmitting a first uplink message via a first set of one or more slots associated with the configured grant using the first frequency allocation based on the first set of one or more slots being of the first slot type. The frequency allocation component 935 is capable of, configured to, or operable to support a means for cancelling a use of the first frequency allocation for transmitting via a second set of one or more slots associated with the configured grant based on the second set of one or more slots being of a second slot type that is different from the first slot type.

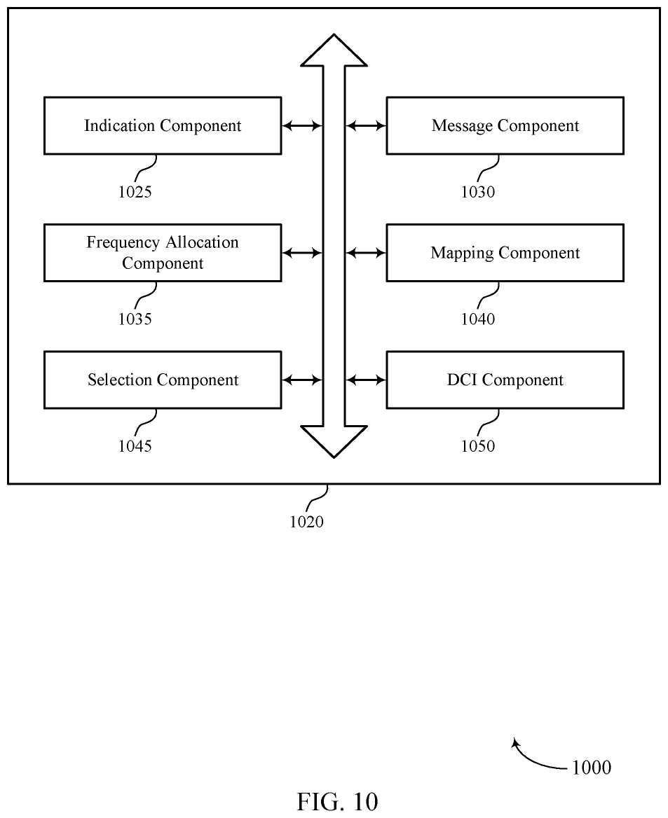

FIG. 10 shows a block diagram 1000 of a communications manager 1020 that supports SBFD communications based on multiple uplink shared channel occasions in a configured grant period SBFD in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of SBFD communications based on multiple uplink shared channel occasions in a configured grant period SBFD as described herein. For example, the communications manager 1020 may include an indication component 1025, a message component 1030, a frequency allocation component 1035, a mapping component 1040, a selection component 1045, a DCI component 1050, or any combination thereof. Each of these components may communicate, directly or indirectly, with one another (e.g., via one or more buses).

The communications manager 1020 may support wireless communication at a UE in accordance with examples as disclosed herein. The indication component 1025 is capable of, configured to, or operable to support a means for receiving an indication of a first frequency allocation associated with a first slot type for a configured grant. The message component 1030 is capable of, configured to, or operable to support a means for transmitting a first uplink message via a first set of one or more slots associated with the configured grant using the first frequency allocation based on the first set of one or more slots being of the first slot type. The frequency allocation component 1035 is capable of, configured to, or operable to support a means for cancelling a use of the first frequency allocation for transmitting via a second set of one or more slots associated with the configured grant based on the second set of one or more slots being of a second slot type that is different from the first slot type.

In some examples, the indication component 1025 is capable of, configured to, or operable to support a means for receiving an indication of a second frequency allocation associated with the second slot type for the configured grant. In some examples, the message component 1030 is capable of, configured to, or operable to support a means for transmitting a second uplink message via the second set of one or more slots associated with the configured grant using the second frequency allocation based on the second set of one or more slots being of the second slot type.

In some examples, the first slot type is a SBFD slot type and the second slot type is an HD slot type, or where the first slot type is the HD slot type and the second slot type is the SBFD slot type.

In some examples, the mapping component 1040 is capable of, configured to, or operable to support a means for mapping the first frequency allocation to an uplink subband of the second set of one or more slots based on applying an offset to the uplink subband with respect to the first set of one or more slots. In some examples, the uplink subband is offset from the first set of one or more slots by a quantity of RBs, a quantity of subbands, or both.

In some examples, the selection component 1045 is capable of, configured to, or operable to support a means for selecting the first frequency allocation for transmission of the first uplink message based on the first set of one or more slots being of the first slot type.

In some examples, the selection component 1045 is capable of, configured to, or operable to support a means for selecting a second frequency allocation for transmission of a second uplink message based on the second set of one or more slots being of the second slot type.

In some examples, the first frequency allocation and the second frequency allocation are common to the first slot type and the second slot type.

In some examples, the selection component 1045 is capable of, configured to, or operable to support a means for selecting the first frequency allocation for transmission of the first uplink message based on whether a start and length indicator for the first set of one or more slots is of the first slot type or the second slot type.

In some examples, the DCI component 1050 is capable of, configured to, or operable to support a means for receiving downlink control information indicating one of the first frequency allocation for transmitting the first uplink message via the first set of one or more slots or a second frequency allocation for transmitting a second uplink message via the second set of one or more slots.

In some examples, a first RB of the first set of one or more slots is associated with an uplink subband from the second set of one or more slots based on a correlation between a position of the first RB of the second set of one or more slots with respect to the second set of one or more slots and a position of a first RB of the first set of one or more slots with respect to the first set of one or more slots.

In some examples, the mapping component 1040 is capable of, configured to, or operable to support a means for mapping a second frequency allocation to the first set of one or more slots based on adding one or more RBs to an uplink subband of the first set of one or more slots, where the first set of one or more slots and the second set of one or more slots have a common first RB.

In some examples, to support receiving the indication of the first frequency allocation, the DCI component 1050 is capable of, configured to, or operable to support a means for receiving downlink control information signaling the first frequency allocation.

In some examples, the DCI component 1050 is capable of, configured to, or operable to support a means for receiving downlink control information indicating one or more of: an offset with respect to a quantity of RBs or a quantity of subbands, a restriction of the first set of one or more slots or the second set of one or more slots, an increase in a quantity of RBs or a quantity of subbands for the first set of one or more slots, or any combination thereof.

In some examples, the first frequency allocation is associated with a first modulation and coding scheme and a second frequency allocation is associated with a second modulation and coding scheme.

In some examples, to support transmitting the first uplink message, the message component 1030 is capable of, configured to, or operable to support a means for transmitting the first uplink message via the second set of one or more slots using a second frequency allocation based on the second set of one or more slots including at least one slot of the first slot type and at least one slot of the second slot type.

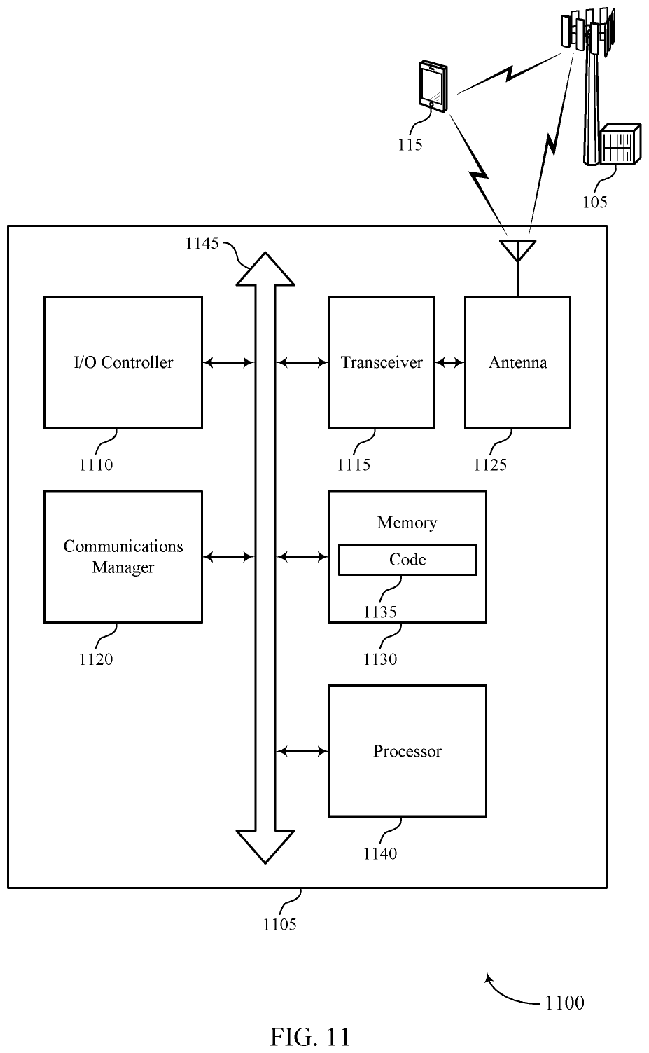

FIG. 11 shows a diagram of a system 1100 including a device 1105 that supports SBFD communications based on multiple uplink shared channel occasions in a configured grant period SBFD in accordance with one or more aspects of the present disclosure. The device 1105 may be an example of or include the components of a device 805, a device 905, or a UE 115 as described herein. The device 1105 may communicate (e.g., wirelessly) with one or more network entities 105, one or more UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a GPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting SBFD communications based on multiple uplink shared channel occasions in a configured grant period). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communication at a UE in accordance with examples as disclosed herein. For example, the communications manager 1120 is capable of, configured to, or operable to support a means for receiving an indication of a first frequency allocation associated with a first slot type for a configured grant. The communications manager 1120 is capable of, configured to, or operable to support a means for transmitting a first uplink message via a first set of one or more slots associated with the configured grant using the first frequency allocation based on the first set of one or more slots being of the first slot type. The communications manager 1120 is capable of, configured to, or operable to support a means for cancelling a use of the first frequency allocation for transmitting via a second set of one or more slots associated with the configured grant based on the second set of one or more slots being of a second slot type that is different from the first slot type.

By including or configuring the communications manager 1120 in accordance with examples as described herein, the device 1105 may support techniques for SBFD communications based on multiple uplink shared channel (e.g., PUSCH) occasions in a CG period, which may result in a more efficient utilization of communication resources, improved data throughput, improved communication between wireless devices, and reduced latency.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 (e.g., directly, indirectly, after pre-processing, without pre-processing) to cause the device 1105 to perform various aspects of SBFD communications based on multiple uplink shared channel occasions in a configured grant period SBFD as described herein, or the processor 1140 and the memory 1130 may be otherwise configured to perform or support such operations.

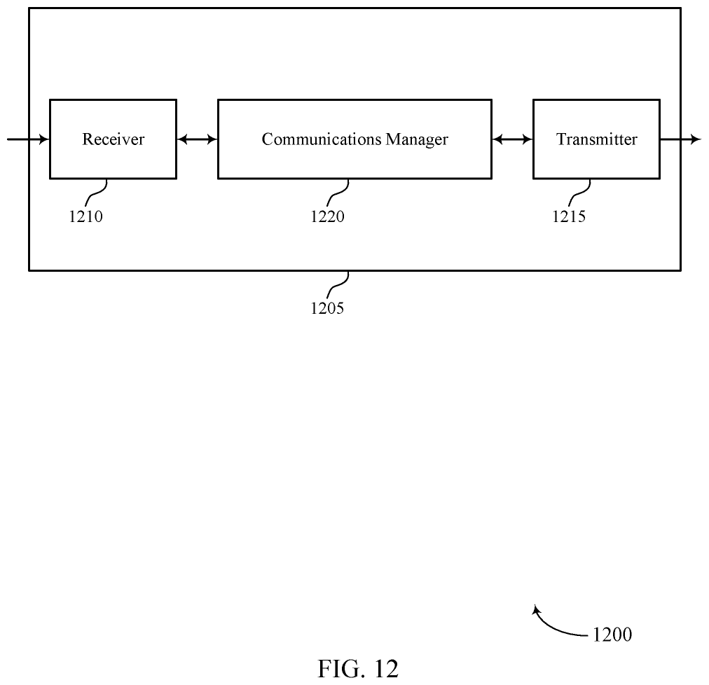

FIG. 12 shows a block diagram 1200 of a device 1205 that supports SBFD communications based on multiple uplink shared channel occasions in a configured grant period SBFD in accordance with one or more aspects of the present disclosure. The device 1205 may be an example of aspects of a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The communications manager 1220, the receiver 1210, the transmitter 1215, or various combinations thereof or various components thereof may be examples of means for performing various aspects of SBFD communications based on multiple uplink shared channel occasions in a configured grant period SBFD as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, a CPU, a GPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1220, the receiver 1210, the transmitter 1215, or various combinations or components thereof may be implemented in hardware, software (e.g., executed by a processor), or any combination thereof. If implemented in code executed by a processor, the functions of the communications manager 1220, the receiver 1210, the transmitter 1215, or various combinations or components thereof may be performed by a general-purpose processor, a DSP, a CPU, a GPU, an ASIC, an FPGA, a microcontroller, or any combination of these or other programmable logic devices (e.g., configured as or otherwise supporting a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity in accordance with examples as disclosed herein. For example, the communications manager 1220 is capable of, configured to, or operable to support a means for transmitting an indication of a first frequency allocation associated with a first slot type for a configured grant. The communications manager 1220 is capable of, configured to, or operable to support a means for receiving a first uplink message via a first set of one or more slots associated with the configured grant using the first frequency allocation based on the first set of one or more slots being of the first slot type. The communications manager 1220 is capable of, configured to, or operable to support a means for cancelling a use of the first frequency allocation for receiving via a second set of one or more slots associated with the configured grant based on the second set of one or more slots being of a second slot type that is different from the first slot type.

By including or configuring the communications manager 1220 in accordance with examples as described herein, the device 1205 (e.g., a processor controlling or otherwise coupled with the receiver 1210, the transmitter 1215, the communications manager 1220, or a combination thereof) may support techniques for SBFD communications based on multiple uplink shared channel (e.g., PUSCH) occasions in a CG period, which may result in a more efficient utilization of communication resources, improved data throughput, improved communications between wireless devices, and reduced latency.

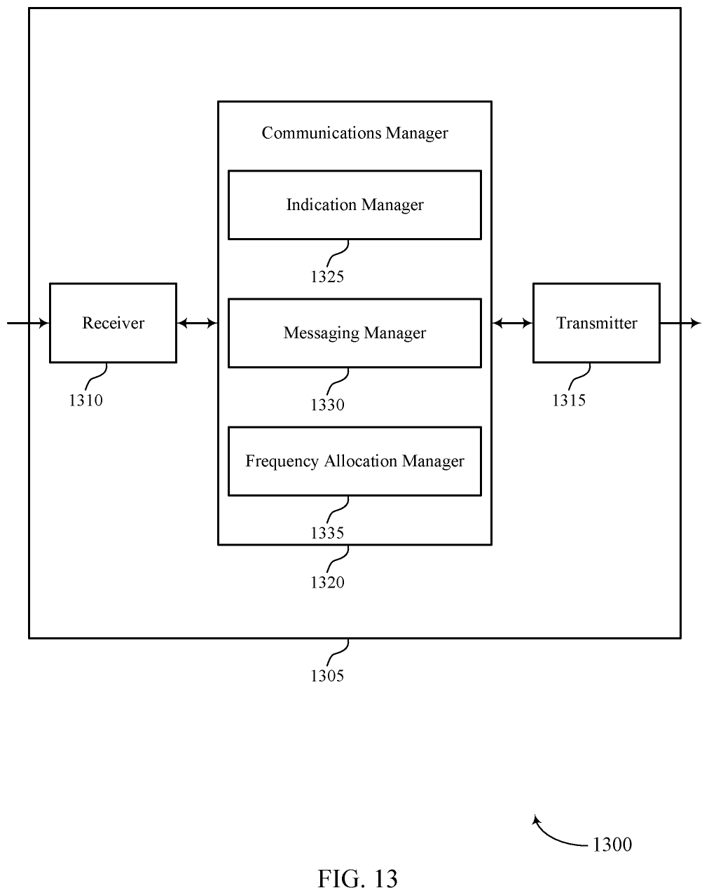

FIG. 13 shows a block diagram 1300 of a device 1305 that supports SBFD communications based on multiple uplink shared channel occasions in a configured grant period in accordance with one or more aspects of the present disclosure. The device 1305 may be an example of aspects of a device 1205 or a network entity 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1305. In some examples, the receiver 1310 may support obtaining information by receiving signals via one or more antennas. Additionally, or alternatively, the receiver 1310 may support obtaining information by receiving signals via one or more wired (e.g., electrical, fiber optic) interfaces, wireless interfaces, or any combination thereof.

The transmitter 1315 may provide a means for outputting (e.g., transmitting, providing, conveying, sending) information generated by other components of the device 1305. For example, the transmitter 1315 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1315 may support outputting information by transmitting signals via one or more antennas. Additionally, or alternatively, the transmitter 1315 may support outputting information by transmitting signals via one or more wired (e.g., electrical, fiber optic) interfaces, wireless interfaces, or any combination thereof. In some examples, the transmitter 1315 and the receiver 1310 may be co-located in a transceiver, which may include or be coupled with a modem.

The device 1305, or various components thereof, may be an example of means for performing various aspects of SBFD communications based on multiple uplink shared channel occasions in a configured grant period SBFD as described herein. For example, the communications manager 1320 may include an indication manager 1325, a messaging manager 1330, a frequency allocation manager 1335, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communication at a network entity in accordance with examples as disclosed herein. The indication manager 1325 is capable of, configured to, or operable to support a means for transmitting an indication of a first frequency allocation associated with a first slot type for a configured grant. The messaging manager 1330 is capable of, configured to, or operable to support a means for receiving a first uplink message via a first set of one or more slots associated with the configured grant using the first frequency allocation based on the first set of one or more slots being of the first slot type. The frequency allocation manager 1335 is capable of, configured to, or operable to support a means for cancelling a use of the first frequency allocation for receiving via a second set of one or more slots associated with the configured grant based on the second set of one or more slots being of a second slot type that is different from the first slot type.

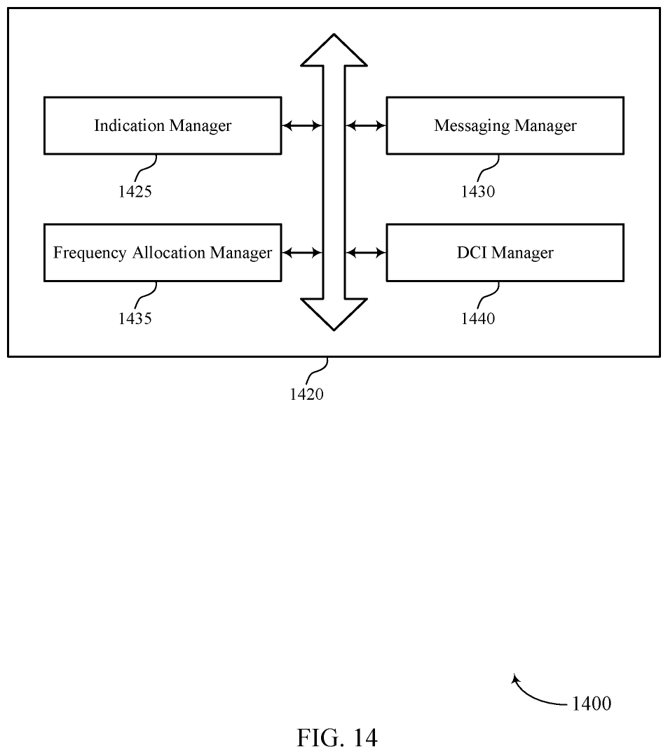

FIG. 14 shows a block diagram 1400 of a communications manager 1420 that supports SBFD communications based on multiple uplink shared channel occasions in a configured grant period in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of SBFD communications based on multiple uplink shared channel occasions in a configured grant period as described herein. For example, the communications manager 1420 may include an indication manager 1425, a messaging manager 1430, a frequency allocation manager 1435, a DCI manager 1440, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1420 may support wireless communication at a network entity in accordance with examples as disclosed herein. The indication manager 1425 is capable of, configured to, or operable to support a means for transmitting an indication of a first frequency allocation associated with a first slot type for a configured grant. The messaging manager 1430 is capable of, configured to, or operable to support a means for receiving a first uplink message via a first set of one or more slots associated with the configured grant using the first frequency allocation based on the first set of one or more slots being of the first slot type. The frequency allocation manager 1435 is capable of, configured to, or operable to support a means for cancelling a use of the first frequency allocation for receiving via a second set of one or more slots associated with the configured grant based on the second set of one or more slots being of a second slot type that is different from the first slot type.

In some examples, the indication manager 1425 is capable of, configured to, or operable to support a means for transmitting an indication of a second frequency allocation associated with the second slot type for the configured grant. In some examples, the messaging manager 1430 is capable of, configured to, or operable to support a means for receiving a second uplink message via the second set of one or more slots associated with the configured grant using the second frequency allocation based on the second set of one or more slots being of the second slot type.

In some examples, the first slot type is a SBFD slot type and the second slot type is an HD slot type, or where the first slot type is the HD slot type and the second slot type is the SBFD slot type.

In some examples, the first frequency allocation is mapped to an uplink subband of the second set of one or more slots based on an offset between the uplink subband and the first set of one or more slots. In some examples, the uplink subband is offset from the first set of one or more slots by a quantity of RBs, a quantity of subbands, or both.

In some examples, the DCI manager 1440 is capable of, configured to, or operable to support a means for transmitting downlink control information indicating one of the first frequency allocation for transmitting the first uplink message via the first set of one or more slots or a second frequency allocation for transmitting a second uplink message via the second set of one or more slots. In some examples, the first frequency allocation and a second frequency allocation are common to the first slot type and the second slot type.

In some examples, a first RB of the first set of one or more slots is associated with an uplink subband from the second set of one or more slots based on a correlation between a position of the first RB of the second set of one or more slots with respect to the second set of one or more slots and a position of a first RB of the first set of one or more slots with respect to the first set of one or more slots.

In some examples, a second frequency allocation is mapped to the first set of one or more slots based on one or more RBs being added to an uplink subband of the first set of one or more slots, where the first set of one or more slots and the second set of one or more slots have a common first RB.

In some examples, to support transmitting the indication of the first frequency allocation, the DCI manager 1440 is capable of, configured to, or operable to support a means for transmitting downlink control information signaling the first frequency allocation.

In some examples, the DCI manager 1440 is capable of, configured to, or operable to support a means for transmitting downlink control information indicating one or more of: an offset with respect to a quantity of RBs or a quantity of subbands, a restriction of the first set of one or more slots or the second set of one or more slots, an increase in a quantity of RBs or a quantity of subbands for the first set of one or more slots, or any combination thereof.

In some examples, the first frequency allocation is associated with a first modulation and coding scheme and a second frequency allocation is associated with a second modulation and coding scheme.

In some examples, to support receiving the first uplink message, the messaging manager 1430 is capable of, configured to, or operable to support a means for receiving the first uplink message via the second set of one or more slots using a second frequency allocation based on the second set of one or more slots including at least one slot of the first slot type and at least one slot of the second slot type.

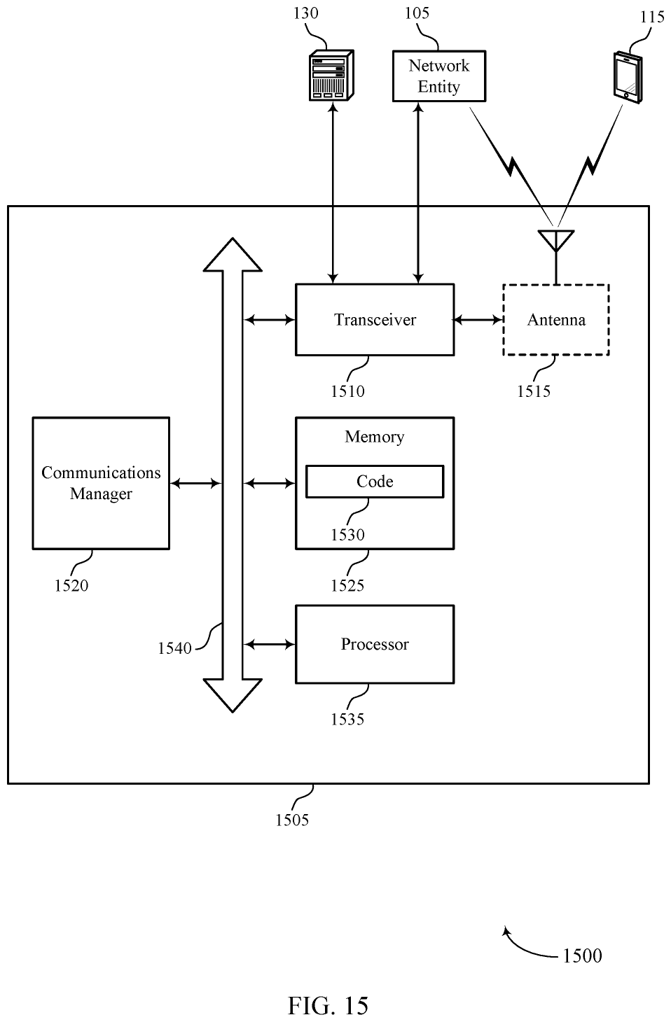

FIG. 15 shows a diagram of a system 1500 including a device 1505 that supports SBFD communications based on multiple uplink shared channel occasions in a configured grant period SBFD in accordance with one or more aspects of the present disclosure. The device 1505 may be an example of or include the components of a device 1205, a device 1305, or a network entity 105 as described herein. The device 1505 may communicate with one or more network entities 105, one or more UEs 115, or any combination thereof, which may include communications over one or more wired interfaces, over one or more wireless interfaces, or any combination thereof. The device 1505 may include components that support outputting and obtaining communications, such as a communications manager 1520, a transceiver 1510, an antenna 1515, a memory 1525, code 1530, and a processor 1535. These components may be in electronic communication or otherwise coupled (e.g., operatively, communicatively, functionally, electronically, electrically) via one or more buses (e.g., a bus 1540).

The transceiver 1510 may support bi-directional communications via wired links, wireless links, or both as described herein. In some examples, the transceiver 1510 may include a wired transceiver and may communicate bi-directionally with another wired transceiver. Additionally, or alternatively, in some examples, the transceiver 1510 may include a wireless transceiver and may communicate bi-directionally with another wireless transceiver. In some examples, the device 1505 may include one or more antennas 1515, which may be capable of transmitting or receiving wireless transmissions (e.g., concurrently). The transceiver 1510 may also include a modem to modulate signals, to provide the modulated signals for transmission (e.g., by one or more antennas 1515, by a wired transmitter), to receive modulated signals (e.g., from one or more antennas 1515, from a wired receiver), and to demodulate signals. In some implementations, the transceiver 1510 may include one or more interfaces, such as one or more interfaces coupled with the one or more antennas 1515 that are configured to support various receiving or obtaining operations, or one or more interfaces coupled with the one or more antennas 1515 that are configured to support various transmitting or outputting operations, or a combination thereof. In some implementations, the transceiver 1510 may include or be configured for coupling with one or more processors or memory components that are operable to perform or support operations based on received or obtained information or signals, or to generate information or other signals for transmission or other outputting, or any combination thereof. In some implementations, the transceiver 1510, or the transceiver 1510 and the one or more antennas 1515, or the transceiver 1510 and the one or more antennas 1515 and one or more processors or memory components (for example, the processor 1535, or the memory 1525, or both), may be included in a chip or chip assembly that is installed in the device 1505. In some examples, the transceiver may be operable to support communications via one or more communications links (e.g., a communication link 125, a backhaul communication link 120, a midhaul communication link 162, a fronthaul communication link 168).

The memory 1525 may include RAM and ROM. The memory 1525 may store computer-readable, computer-executable code 1530 including instructions that, when executed by the processor 1535, cause the device 1505 to perform various functions described herein. The code 1530 may be stored in a non-transitory computer-readable medium such as system memory or another type of memory. In some cases, the code 1530 may not be directly executable by the processor 1535 but may cause a computer (e.g., when compiled and executed) to perform functions described herein. In some cases, the memory 1525 may contain, among other things, a BIOS which may control basic hardware or software operation such as the interaction with peripheral components or devices.

The processor 1535 may include an intelligent hardware device (e.g., a general-purpose processor, a DSP, an ASIC, a CPU, a GPU, an FPGA, a microcontroller, a programmable logic device, discrete gate or transistor logic, a discrete hardware component, or any combination thereof). In some cases, the processor 1535 may be configured to operate a memory array using a memory controller. In some other cases, a memory controller may be integrated into the processor 1535. The processor 1535 may be configured to execute computer-readable instructions stored in a memory (e.g., the memory 1525) to cause the device 1505 to perform various functions (e.g., functions or tasks supporting SBFD communications based on multiple uplink shared channel occasions in a configured grant period). For example, the device 1505 or a component of the device 1505 may include a processor 1535 and memory 1525 coupled with the processor 1535, the processor 1535 and memory 1525 configured to perform various functions described herein. The processor 1535 may be an example of a cloud-computing platform (e.g., one or more physical nodes and supporting software such as operating systems, virtual machines, or container instances) that may host the functions (e.g., by executing code 1530) to perform the functions of the device 1505. The processor 1535 may be any one or more suitable processors capable of executing scripts or instructions of one or more software programs stored in the device 1505 (such as within the memory 1525). In some implementations, the processor 1535 may be a component of a processing system. A processing system may generally refer to a system or series of machines or components that receives inputs and processes the inputs to produce a set of outputs (which may be passed to other systems or components of, for example, the device 1505). For example, a processing system of the device 1505 may refer to a system including the various other components or subcomponents of the device 1505, such as the processor 1535, or the transceiver 1510, or the communications manager 1520, or other components or combinations of components of the device 1505. The processing system of the device 1505 may interface with other components of the device 1505, and may process information received from other components (such as inputs or signals) or output information to other components. For example, a chip or modem of the device 1505 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1505 may transmit information output from the chip or modem. Additionally, or alternatively, in some implementations, the one or more interfaces may refer to an interface between the processing system of the chip or modem and a receiver, such that the device 1505 may obtain information or signal inputs, and the information may be passed to the processing system. A person having ordinary skill in the art will readily recognize that a first interface also may obtain information or signal inputs, and a second interface also may output information or signal outputs.

In some examples, a bus 1540 may support communications of (e.g., within) a protocol layer of a protocol stack. In some examples, a bus 1540 may support communications associated with a logical channel of a protocol stack (e.g., between protocol layers of a protocol stack), which may include communications performed within a component of the device 1505, or between different components of the device 1505 that may be co-located or located in different locations (e.g., where the device 1505 may refer to a system in which one or more of the communications manager 1520, the transceiver 1510, the memory 1525, the code 1530, and the processor 1535 may be located in one of the different components or divided between different components).

In some examples, the communications manager 1520 may manage aspects of communications with a core network 130 (e.g., via one or more wired or wireless backhaul links). For example, the communications manager 1520 may manage the transfer of data communications for client devices, such as one or more UEs 115. In some examples, the communications manager 1520 may manage communications with other network entities 105, and may include a controller or scheduler for controlling communications with UEs 115 in cooperation with other network entities 105. In some examples, the communications manager 1520 may support an X2 interface within an LTE/LTE-A wireless communications network technology to provide communication between network entities 105.

The communications manager 1520 may support wireless communication at a network entity in accordance with examples as disclosed herein. For example, the communications manager 1520 is capable of, configured to, or operable to support a means for transmitting an indication of a first frequency allocation associated with a first slot type for a configured grant. The communications manager 1520 is capable of, configured to, or operable to support a means for receiving a first uplink message via a first set of one or more slots associated with the configured grant using the first frequency allocation based on the first set of one or more slots being of the first slot type. The communications manager 1520 is capable of, configured to, or operable to support a means for cancelling a use of the first frequency allocation for receiving via a second set of one or more slots associated with the configured grant based on the second set of one or more slots being of a second slot type that is different from the first slot type.

By including or configuring the communications manager 1520 in accordance with examples as described herein, the device 1505 may support techniques for SBFD communications based on multiple uplink shared channel (e.g., PUSCH) occasions in a CG period, which may result in a more efficient utilization of communication resources, improved data throughput, improved communications between wireless devices, and reduced latency.

In some examples, the communications manager 1520 may be configured to perform various operations (e.g., receiving, obtaining, monitoring, outputting, transmitting) using or otherwise in cooperation with the transceiver 1510, the one or more antennas 1515 (e.g., where applicable), or any combination thereof. Although the communications manager 1520 is illustrated as a separate component, in some examples, one or more functions described with reference to the communications manager 1520 may be supported by or performed by the transceiver 1510, the processor 1535, the memory 1525, the code 1530, or any combination thereof. For example, the code 1530 may include instructions executable by the processor 1535 (e.g., directly, indirectly, after pre-processing, without pre-processing) to cause the device 1505 to perform various aspects of SBFD communications based on multiple uplink shared channel occasions in a configured grant period as described herein, or the processor 1535 and the memory 1525 may be otherwise configured to perform or support such operations.

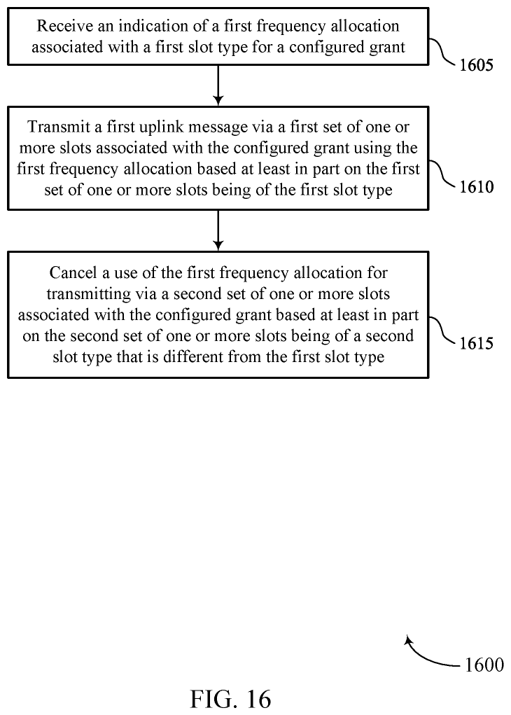

FIG. 16 shows a flowchart illustrating a method 1600 that supports SBFD communications based at least in part on multiple uplink shared channel occasions in a configured grant period in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1605, the method may include receiving an indication of a first frequency allocation associated with a first slot type for a configured grant. The operations of 1605 may be performed in accordance with examples as disclosed herein. In some examples, aspects of the operations of 1605 may be performed by an indication component 1025 as described with reference to FIG. 10.

At 1610, the method may include transmitting a first uplink message via a first set of one or more slots associated with the configured grant using the first frequency allocation based at least in part on the first set of one or more slots being of the first slot type. The operations of 1610 may be performed in accordance with examples as disclosed herein. In some examples, aspects of the operations of 1610 may be performed by a message component 1030 as described with reference to FIG. 10.

At 1615, the method may include cancelling a use of the first frequency allocation for transmitting via a second set of one or more slots associated with the configured grant based at least in part on the second set of one or more slots being of a second slot type that is different from the first slot type. The operations of 1615 may be performed in accordance with examples as disclosed herein. In some examples, aspects of the operations of 1615 may be performed by a frequency allocation component 1035 as described with reference to FIG. 10.

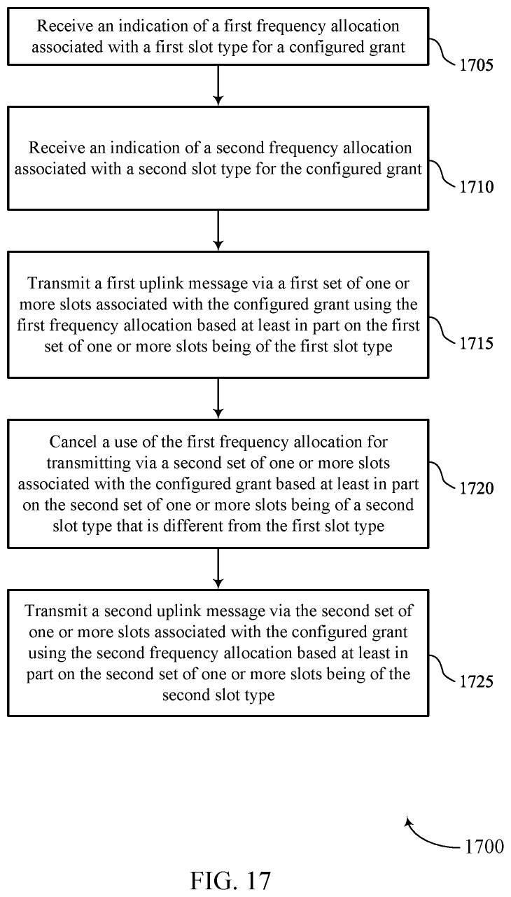

FIG. 17 shows a flowchart illustrating a method 1700 that supports SBFD communications based at least in part on multiple uplink shared channel occasions in a configured grant period in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1705, the method may include receiving an indication of a first frequency allocation associated with a first slot type for a configured grant. The operations of 1705 may be performed in accordance with examples as disclosed herein. In some examples, aspects of the operations of 1705 may be performed by an indication component 1025 as described with reference to FIG. 10.

At 1710, the method may include receiving an indication of a second frequency allocation associated with a second slot type for the configured grant. The operations of 1710 may be performed in accordance with examples as disclosed herein. In some examples, aspects of the operations of 1710 may be performed by an indication component 1025 as described with reference to FIG. 10.

At 1715, the method may include transmitting a first uplink message via a first set of one or more slots associated with the configured grant using the first frequency allocation based on the first set of one or more slots being of the first slot type. The operations of 1715 may be performed in accordance with examples as disclosed herein. In some examples, aspects of the operations of 1715 may be performed by a message component 1030 as described with reference to FIG. 10.

At 1720, the method may include cancelling a use of the first frequency allocation for transmitting via a second set of one or more slots associated with the configured grant based on the second set of one or more slots being of a second slot type that is different from the first slot type. The operations of 1720 may be performed in accordance with examples as disclosed herein. In some examples, aspects of the operations of 1720 may be performed by a frequency allocation component 1035 as described with reference to FIG. 10.

At 1725, the method may include transmitting a second uplink message via the second set of one or more slots associated with the configured grant using the second frequency allocation based at least in part on the second set of one or more slots being of the second slot type. The operations of 1725 may be performed in accordance with examples as disclosed herein. In some examples, aspects of the operations of 1725 may be performed by a message component 1030 as described with reference to FIG. 10.

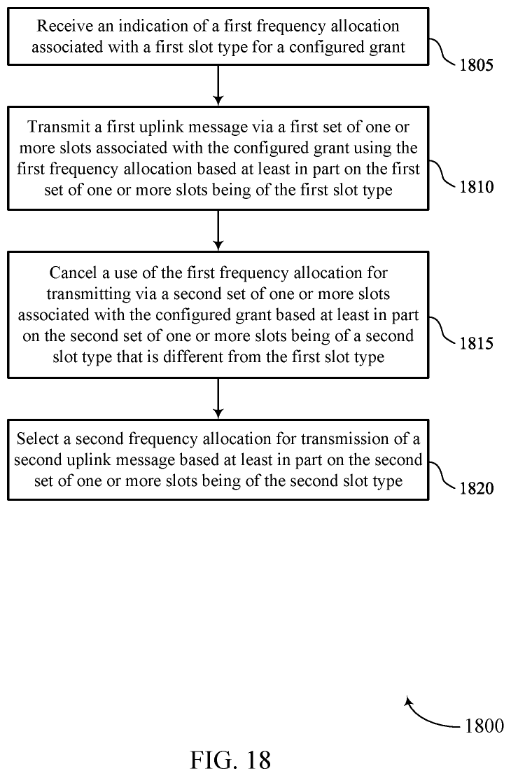

FIG. 18 shows a flowchart illustrating a method 1800 that supports SBFD communications based at least in part on multiple uplink shared channel occasions in a configured grant period in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the wireless UE to perform the described functions. Additionally, or alternatively, the wireless UE may perform aspects of the described functions using special-purpose hardware.

At 1805, the method may include receiving an indication of a first frequency allocation associated with a first slot type for a configured grant. The operations of 1805 may be performed in accordance with examples as disclosed herein. In some examples, aspects of the operations of 1805 may be performed by an indication component 1025 as described with reference to FIG. 10.

At 1810, the method may include transmitting a first uplink message via a first set of one or more slots associated with the configured grant using the first frequency allocation based at least in part on the first set of one or more slots being of the first slot type. The operations of 1810 may be performed in accordance with examples as disclosed herein. In some examples, aspects of the operations of 1810 may be performed by a message component 1030 as described with reference to FIG. 10.

At 1815, the method may include cancelling a use of the first frequency allocation for transmitting via a second set of one or more slots associated with the configured grant based at least in part on the second set of one or more slots being of a second slot type that is different from the first slot type. The operations of 1815 may be performed in accordance with examples as disclosed herein. In some examples, aspects of the operations of 1815 may be performed by a frequency allocation component 1035 as described with reference to FIG. 10.

At 1820, the method may include selecting a second frequency allocation for transmission of a second uplink message based at least in part on the second set of one or more slots being of the second slot type. The operations of 1820 may be performed in accordance with examples as disclosed herein. In some examples, aspects of the operations of 1820 may be performed by a selection component 1045 as described with reference to FIG. 10.

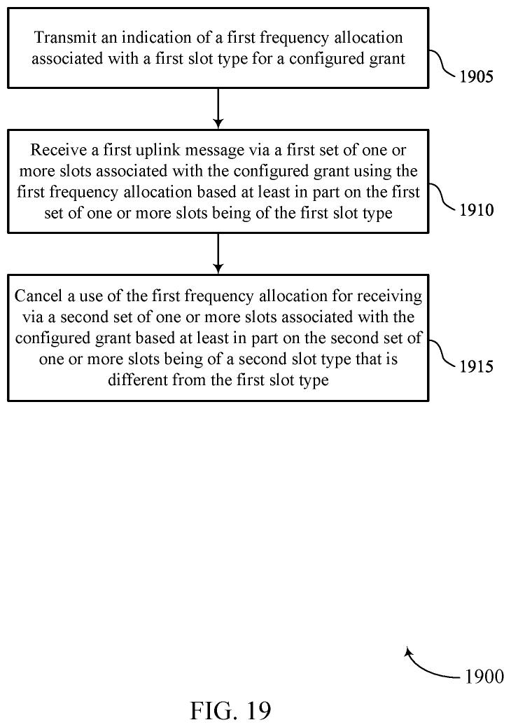

FIG. 19 shows a flowchart illustrating a method 1900 that supports SBFD communications based at least in part on multiple uplink shared channel occasions in a configured grant period in accordance with aspects of the present disclosure. The operations of the method 1900 may be implemented by a network entity or its components as described herein. For example, the operations of the method 1900 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 1905, the method may include transmitting an indication of a first frequency allocation associated with a first slot type for a configured grant. The operations of 1905 may be performed in accordance with examples as disclosed herein. In some examples, aspects of the operations of 1905 may be performed by an indication manager 1425 as described with reference to FIG. 14.

At 1910, the method may include receiving a first uplink message via a first set of one or more slots associated with the configured grant using the first frequency allocation based at least in part on the first set of one or more slots being of the first slot type. The operations of 1910 may be performed in accordance with examples as disclosed herein. In some examples, aspects of the operations of 1910 may be performed by a messaging manager 1430 as described with reference to FIG. 14.

At 1915, the method may include cancelling a use of the first frequency allocation for receiving via a second set of one or more slots associated with the configured grant based at least in part on the second set of one or more slots being of a second slot type that is different from the first slot type. The operations of 1915 may be performed in accordance with examples as disclosed herein. In some examples, aspects of the operations of 1915 may be performed by a frequency allocation manager 1435 as described with reference to FIG. 14.

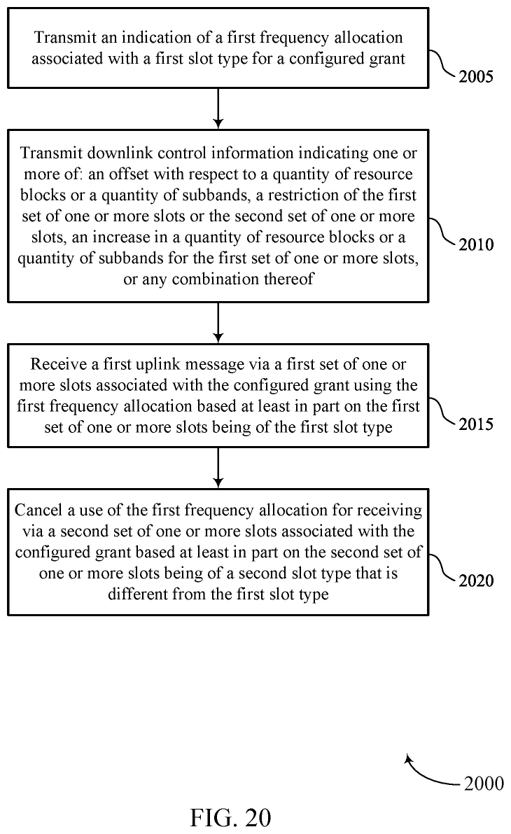

FIG. 20 shows a flowchart illustrating a method 2000 that supports SBFD communications based at least in part on multiple uplink shared channel occasions in a configured grant period in accordance with aspects of the present disclosure. The operations of the method 2000 may be implemented by a network entity or its components as described herein. For example, the operations of the method 2000 may be performed by a network entity as described with reference to FIGS. 1 through 7 and 12 through 15. In some examples, a network entity may execute a set of instructions to control the functional elements of the wireless network entity to perform the described functions. Additionally, or alternatively, the wireless network entity may perform aspects of the described functions using special-purpose hardware.

At 2005, the method may include transmitting an indication of a first frequency allocation associated with a first slot type for a configured grant. The operations of 2005 may be performed in accordance with examples as disclosed herein. In some examples, aspects of the operations of 2005 may be performed by an indication manager 1425 as described with reference to FIG. 14.

At 2010, the method may include transmitting downlink control information indicating one or more of: an offset with respect to a quantity of RBs or a quantity of subbands, a restriction of the first set of one or more slots or the second set of one or more slots, an increase in a quantity of RBs or a quantity of subbands for the first set of one or more slots, or any combination thereof. The operations of 2010 may be performed in accordance with examples as disclosed herein. In some examples, aspects of the operations of 2010 may be performed by a DCI manager 1440 as described with reference to FIG. 14.

At 2015, the method may include receiving a first uplink message via a first set of one or more slots associated with the configured grant using the first frequency allocation based at least in part on the first set of one or more slots being of the first slot type. The operations of 2015 may be performed in accordance with examples as disclosed herein. In some examples, aspects of the operations of 2015 may be performed by a messaging manager 1430 as described with reference to FIG. 14.

At 2020, the method may include cancelling a use of the first frequency allocation for receiving via a second set of one or more slots associated with the configured grant based at least in part on the second set of one or more slots being of a second slot type that is different from the first slot type. The operations of 2020 may be performed in accordance with examples as disclosed herein. In some examples, aspects of the operations of 2020 may be performed by a frequency allocation manager 1435 as described with reference to FIG. 14.

The following provides an overview of aspects of the present disclosure:

Aspect 1: A method for wireless communication at a UE, comprising: receiving an indication of a first frequency allocation associated with a first slot type for a configured grant; transmitting a first uplink message via a first set of one or more slots associated with the configured grant using the first frequency allocation based at least in part on the first set of one or more slots being of the first slot type; and cancelling a use of the first frequency allocation for transmitting via a second set of one or more slots associated with the configured grant based at least in part on the second set of one or more slots being of a second slot type that is different from the first slot type.

Aspect 2: The method of aspect 1, further comprising: receiving an indication of a second frequency allocation associated with the second slot type for the configured grant; and transmitting a second uplink message via the second set of one or more slots associated with the configured grant using the second frequency allocation based at least in part on the second set of one or more slots being of the second slot type.

Aspect 3: The method of any of aspects 1 through 2, wherein the first slot type is a subband full-duplex slot type and the second slot type is a half-duplex slot type, or wherein the first slot type is the half-duplex slot type and the second slot type is the subband full-duplex slot type.

Aspect 4: The method of any of aspects 1 through 3, further comprising: mapping the first frequency allocation to an uplink subband of the second set of one or more slots based at least in part on applying an offset to the uplink subband with respect to the first set of one or more slots.

Aspect 5: The method of aspect 4, wherein the uplink subband is offset from the first set of one or more slots by a quantity of resource blocks, a quantity of subbands, or both.

Aspect 6: The method of any of aspects 1 through 5, further comprising: selecting the first frequency allocation for transmission of the first uplink message based at least in part on the first set of one or more slots being of the first slot type.

Aspect 7: The method of any of aspects 1 through 6, further comprising: selecting a second frequency allocation for transmission of a second uplink message based at least in part on the second set of one or more slots being of the second slot type.

Aspect 8: The method of aspect 7, wherein the first frequency allocation and the second frequency allocation are common to the first slot type and the second slot type.

Aspect 9: The method of any of aspects 1 through 8, further comprising: selecting the first frequency allocation for transmission of the first uplink message based at least in part on whether a start and length indicator for the first set of one or more slots is of the first slot type or the second slot type.

Aspect 10: The method of any of aspects 1 through 9, further comprising: receiving downlink control information indicating one of the first frequency allocation for transmitting the first uplink message via the first set of one or more slots or a second frequency allocation for transmitting a second uplink message via the second set of one or more slots.

Aspect 11: The method of any of aspects 1 through 10, wherein a first resource block of the first set of one or more slots is associated with an uplink subband from the second set of one or more slots based at least in part on a correlation between a position of the first resource block of the second set of one or more slots with respect to the second set of one or more slots and a position of a first resource block of the first set of one or more slots with respect to the first set of one or more slots.

Aspect 12: The method of any of aspects 1 through 11, further comprising: mapping a second frequency allocation to the first set of one or more slots based at least in part on adding one or more resource blocks to an uplink subband of the first set of one or more slots, wherein the first set of one or more slots and the second set of one or more slots have a common first resource block.

Aspect 13: The method of any of aspects 1 through 12, wherein receiving the indication of the first frequency allocation comprises: receiving downlink control information signaling the first frequency allocation.

Aspect 14: The method of any of aspects 1 through 13, further comprising: receiving downlink control information indicating one or more of: an offset with respect to a quantity of resource blocks or a quantity of subbands, a restriction of the first set of one or more slots or the second set of one or more slots, an increase in a quantity of resource blocks or a quantity of subbands for the first set of one or more slots, or any combination thereof.

Aspect 15: The method of any of aspects 1 through 14, wherein the first frequency allocation is associated with a first modulation and coding scheme and a second frequency allocation is associated with a second modulation and coding scheme.

Aspect 16: The method of any of aspects 1 through 15, wherein transmitting the first uplink message comprises: transmitting the first uplink message via the second set of one or more slots using a second frequency allocation based at least in part on the second set of one or more slots including at least one slot of the first slot type and at least one slot of the second slot type.

Aspect 17: A method for wireless communication at a network entity, comprising: transmitting an indication of a first frequency allocation associated with a first slot type for a configured grant; receiving a first uplink message via a first set of one or more slots associated with the configured grant using the first frequency allocation based at least in part on the first set of one or more slots being of the first slot type; and cancelling a use of the first frequency allocation for receiving via a second set of one or more slots associated with the configured grant based at least in part on the second set of one or more slots being of a second slot type that is different from the first slot type.

Aspect 18: The method of aspect 17, further comprising: transmitting an indication of a second frequency allocation associated with the second slot type for the configured grant; and receiving a second uplink message via the second set of one or more slots associated with the configured grant using the second frequency allocation based at least in part on the second set of one or more slots being of the second slot type.

Aspect 19: The method of any of aspects 17 through 18, wherein the first slot type is a subband full-duplex slot type and the second slot type is a half-duplex slot type, or wherein the first slot type is the half-duplex slot type and the second slot type is the subband full-duplex slot type.

Aspect 20: The method of any of aspects 17 through 19, wherein the first frequency allocation is mapped to an uplink subband of the second set of one or more slots based at least in part on an offset between the uplink subband and the first set of one or more slots.

Aspect 21: The method of aspect 20, wherein the uplink subband is offset from the first set of one or more slots by a quantity of resource blocks, a quantity of subbands, or both.

Aspect 22: The method of any of aspects 17 through 21, further comprising: transmitting downlink control information indicating one of the first frequency allocation for transmitting the first uplink message via the first set of one or more slots or a second frequency allocation for transmitting a second uplink message via the second set of one or more slots.

Aspect 23: The method of any of aspects 17 through 22, wherein the first frequency allocation and a second frequency allocation are common to the first slot type and the second slot type.

Aspect 24: The method of any of aspects 17 through 23, wherein a first resource block of the first set of one or more slots is associated with an uplink subband from the second set of one or more slots based at least in part on a correlation between a position of the first resource block of the second set of one or more slots with respect to the second set of one or more slots and a position of a first resource block of the first set of one or more slots with respect to the first set of one or more slots.

Aspect 25: The method of any of aspects 17 through 24, wherein a second frequency allocation is mapped to the first set of one or more slots based at least in part on one or more resource blocks being added to an uplink subband of the first set of one or more slots, wherein the first set of one or more slots and the second set of one or more slots have a common first resource block.

Aspect 26: The method of any of aspects 17 through 25, wherein transmitting the indication of the first frequency allocation comprises: transmitting downlink control information signaling the first frequency allocation.

Aspect 27: The method of any of aspects 17 through 26, further comprising: transmitting downlink control information indicating one or more of: an offset with respect to a quantity of resource blocks or a quantity of subbands, a restriction of the first set of one or more slots or the second set of one or more slots, an increase in a quantity of resource blocks or a quantity of subbands for the first set of one or more slots, or any combination thereof.

Aspect 28: The method of any of aspects 17 through 27, wherein the first frequency allocation is associated with a first modulation and coding scheme and a second frequency allocation is associated with a second modulation and coding scheme.

Aspect 29: The method of any of aspects 17 through 28, wherein receiving the first uplink message comprises: receiving the first uplink message via the second set of one or more slots using a second frequency allocation based at least in part on the second set of one or more slots including at least one slot of the first slot type and at least one slot of the second slot type.

Aspect 30: An apparatus for wireless communication at a UE, comprising at least one processor; and memory coupled with the at least one processor, the memory storing instructions executable by the at least one processor to cause the UE to perform a method of any of aspects 1 through 16.

Aspect 31: An apparatus for wireless communication at a UE, comprising means for performing a method of any of aspects 1 through 16.

Aspect 32: A non-transitory computer-readable medium storing code for wireless communication at a UE, the code comprising instructions executable by a processor to perform a method of any of aspects 1 through 16.

Aspect 33: An apparatus for wireless communication at a network entity, comprising at least one processor; and memory coupled with the at least one processor, the memory storing instructions executable by the at least one processor to cause the network entity to perform a method of any of aspects 17 through 29.

Aspect 34: An apparatus for wireless communication at a network entity, comprising means for performing a method of any of aspects 17 through 29.

Aspect 35: A non-transitory computer-readable medium storing code for wireless communication at a network entity, the code comprising instructions executable by at least one processor to perform a method of any of aspects 17 through 29.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, or any combination thereof. Software shall be construed broadly to mean instructions, instruction sets, code, code segments, program code, programs, subprograms, software modules, applications, software applications, software packages, routines, subroutines, objects, executables, threads of execution, procedures, or functions, whether referred to as software, firmware, middleware, microcode, hardware description language, or otherwise. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, phase change memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., including a list of items prefaced by a phrase such as “at least one of” or “one or more of”) indicates an inclusive list such that, for example, a list of at least one of A, B, or C means, e.g., A or B or C or AB or AC or BC or ABC (i.e., A and B and C). Also, as used herein, the phrase “based at least in part on” shall not be construed as a reference to a closed set of conditions. For example, an example step that is described as “based at least in part on condition A” may be based at least in part on both a condition A and a condition B without departing from the scope of the present disclosure. In other words, as used herein, the phrase “based at least in part on” shall be construed in the same manner as the phrase “based at least in part on.” As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The term “determine” or “determining” or “identify” or “identifying” encompasses a variety of actions and, therefore, “determining” or “identifying” can include calculating, computing, processing, deriving, investigating, looking up (such as via looking up in a table, a database or another data structure), ascertaining and the like. Also, “determining” or “identifying” can include receiving (such as receiving information or signaling, e.g., receiving information or signaling for determining, receiving information or signaling for identifying), accessing (such as accessing data in a memory, or accessing information) and the like. Also, “determining” or “identifying” can include resolving, obtaining, selecting, choosing, establishing and other such similar actions. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
at least one processor; and
memory coupled with the at least one processor, the memory storing instructions executable by the at least one processor to cause the UE to:
receive an indication of a first frequency allocation associated with a first slot type for a configured grant;
transmit a first uplink message via a first set of one or more slots associated with the configured grant using the first frequency allocation based at least in part on the first set of one or more slots being of the first slot type; and
cancel a use of the first frequency allocation for transmitting via a second set of one or more slots associated with the configured grant based at least in part on the second set of one or more slots being of a second slot type that is different from the first slot type.

2. The apparatus of claim 1, wherein the instructions are further executable by the at least one processor to cause the UE to:
receive an indication of a second frequency allocation associated with the second slot type for the configured grant; and
transmit a second uplink message via the second set of one or more slots associated with the configured grant using the second frequency allocation based at least in part on the second set of one or more slots being of the second slot type.

3. The apparatus of claim 1, wherein the first slot type is a subband full-duplex slot type and the second slot type is a half-duplex slot type, or wherein the first slot type is the half-duplex slot type and the second slot type is the subband full-duplex slot type.

4. The apparatus of claim 1, wherein the instructions are further executable by the at least one processor to cause the UE to:
map the first frequency allocation to an uplink subband of the second set of one or more slots based at least in part on applying an offset to the uplink subband with respect to the first set of one or more slots.

5. The apparatus of claim 4, wherein the uplink subband is offset from the first set of one or more slots by a quantity of resource blocks, a quantity of subbands, or both.

6. The apparatus of claim 1, wherein the instructions are further executable by the at least one processor to cause the UE to:
select the first frequency allocation for transmission of the first uplink message based at least in part on the first set of one or more slots being of the first slot type.

7. The apparatus of claim 1, wherein the instructions are further executable by the at least one processor to cause the UE to:
select a second frequency allocation for transmission of a second uplink message based at least in part on the second set of one or more slots being of the second slot type.

8. The apparatus of claim 7, wherein the first frequency allocation and the second frequency allocation are common to the first slot type and the second slot type.

9. The apparatus of claim 1, wherein the instructions are further executable by the at least one processor to cause the UE to:
select the first frequency allocation for transmission of the first uplink message based at least in part on whether a start and length indicator for the first set of one or more slots is of the first slot type or the second slot type.

10. The apparatus of claim 1, wherein the instructions are further executable by the at least one processor to cause the UE to:
receive downlink control information indicating one of the first frequency allocation for transmitting the first uplink message via the first set of one or more slots or a second frequency allocation for transmitting a second uplink message via the second set of one or more slots.

11. The apparatus of claim 1, wherein a first resource block of the first set of one or more slots is associated with an uplink subband from the second set of one or more slots based at least in part on a correlation between a position of the first resource block of the second set of one or more slots with respect to the second set of one or more slots and a position of a first resource block of the first set of one or more slots with respect to the first set of one or more slots.

12. The apparatus of claim 1, wherein the instructions are further executable by the at least one processor to cause the UE to:
map a second frequency allocation to the first set of one or more slots based at least in part on adding one or more resource blocks to an uplink subband of the first set of one or more slots, wherein the first set of one or more slots and the second set of one or more slots have a common first resource block.

13. The apparatus of claim 1, wherein the instructions to receive the indication of the first frequency allocation are executable by the at least one processor to cause the UE to:
receive downlink control information signaling the first frequency allocation.

14. The apparatus of claim 1, wherein the instructions are further executable by the at least one processor to cause the UE to:
receive downlink control information indicating one or more of: an offset with respect to a quantity of resource blocks or a quantity of subbands, a restriction of the first set of one or more slots or the second set of one or more slots, an increase in a quantity of resource blocks or a quantity of subbands for the first set of one or more slots, or any combination thereof.

15. The apparatus of claim 1, wherein the first frequency allocation is associated with a first modulation and coding scheme and a second frequency allocation is associated with a second modulation and coding scheme.

16. The apparatus of claim 1, wherein the instructions to transmit the first uplink message are executable by the at least one processor to cause the UE to:
transmit the first uplink message via the second set of one or more slots using a second frequency allocation based at least in part on the second set of one or more slots including at least one slot of the first slot type and at least one slot of the second slot type.

17. An apparatus for wireless communication at a network entity, comprising:
at least one processor; and
memory coupled with the at least one processor, the memory storing instructions executable by the at least one processor to cause the network entity to:
transmit an indication of a first frequency allocation associated with a first slot type for a configured grant;
receive a first uplink message via a first set of one or more slots associated with the configured grant using the first frequency allocation based at least in part on the first set of one or more slots being of the first slot type; and
cancel a use of the first frequency allocation for receiving via a second set of one or more slots associated with the configured grant based at least in part on the second set of one or more slots being of a second slot type that is different from the first slot type.

18. The apparatus of claim 17, wherein the instructions are further executable by the at least one processor to cause the network entity to:
transmit an indication of a second frequency allocation associated with the second slot type for the configured grant; and
receive a second uplink message via the second set of one or more slots associated with the configured grant using the second frequency allocation based at least in part on the second set of one or more slots being of the second slot type.

19. The apparatus of claim 17, wherein the first slot type is a subband full-duplex slot type and the second slot type is a half-duplex slot type, or wherein the first slot type is the half-duplex slot type and the second slot type is the subband full-duplex slot type.

20. The apparatus of claim 17, wherein the first frequency allocation is mapped to an uplink subband of the second set of one or more slots based at least in part on an offset between the uplink subband and the first set of one or more slots.

21. The apparatus of claim 20, wherein the uplink subband is offset from the first set of one or more slots by a quantity of resource blocks, a quantity of subbands, or both.

22. The apparatus of claim 17, wherein the instructions are further executable by the at least one processor to cause the network entity to:
transmit downlink control information indicating one of the first frequency allocation for transmitting the first uplink message via the first set of one or more slots or a second frequency allocation for transmitting a second uplink message via the second set of one or more slots.

23. The apparatus of claim 17, wherein the first frequency allocation and a second frequency allocation are common to the first slot type and the second slot type.

24. The apparatus of claim 17, wherein a first resource block of the first set of one or more slots is associated with an uplink subband from the second set of one or more slots based at least in part on a correlation between a position of the first resource block of the second set of one or more slots with respect to the second set of one or more slots and a position of a first resource block of the first set of one or more slots with respect to the first set of one or more slots.

25. The apparatus of claim 17, wherein a second frequency allocation is mapped to the first set of one or more slots based at least in part on one or more resource blocks being added to an uplink subband of the first set of one or more slots, wherein the first set of one or more slots and the second set of one or more slots have a common first resource block.

26. The apparatus of claim 17, wherein the instructions to transmit the indication of the first frequency allocation are executable by the at least one processor to cause the network entity to:
transmit downlink control information signaling the first frequency allocation.

27. The apparatus of claim 17, wherein the instructions are further executable by the at least one processor to cause the network entity to:
transmit downlink control information indicating one or more of: an offset with respect to a quantity of resource blocks or a quantity of subbands, a restriction of the first set of one or more slots or the second set of one or more slots, an increase in a quantity of resource blocks or a quantity of subbands for the first set of one or more slots, or any combination thereof.

28. The apparatus of claim 17, wherein the first frequency allocation is associated with a first modulation and coding scheme and a second frequency allocation is associated with a second modulation and coding scheme.

29. A method for wireless communication at a user equipment (UE), comprising:
receiving an indication of a first frequency allocation associated with a first slot type for a configured grant;
transmitting a first uplink message via a first set of one or more slots associated with the configured grant using the first frequency allocation based at least in part on the first set of one or more slots being of the first slot type; and
cancelling a use of the first frequency allocation for transmitting via a second set of one or more slots associated with the configured grant based at least in part on the second set of one or more slots being of a second slot type that is different from the first slot type.

30. A method for wireless communication at a network entity, comprising:
transmitting an indication of a first frequency allocation associated with a first slot type for a configured grant;
receiving a first uplink message via a first set of one or more slots associated with the configured grant using the first frequency allocation based at least in part on the first set of one or more slots being of the first slot type; and
cancelling a use of the first frequency allocation for receiving via a second set of one or more slots associated with the configured grant based at least in part on the second set of one or more slots being of a second slot type that is different from the first slot type.
